(19) United States
(12) Patent Application Publication
(10) Pub. No.: US 2020/0317143 A1
(43) Pub. Date: Oct. 8, 2020

(54) BOTTOM SEAL FOR USE WITH RV SLIDE OUT ROOMS

(71) Applicant: Tobin Michael Goode, Granger, IN (US)

(72) Inventor: Tobin Michael Goode, Granger, IN (US)

(21) Appl. No.: 16/376,668

(22) Filed: Apr. 5, 2019

(51) Int. Cl. B60R 13/06; B60R 13/07; B62D 21/14; F16J 15/3232; F16J 15/02; B62D 63/06

(52) U.S. Cl. CPC B60R 13/06; B60R 13/07; B62D 21/14; B60Y 2200/147; F16J 15/024; B62D 63/061; F16J 15/3232

(57) ABSTRACT

A bottom seal assembly (500) is disclosed for use with mobile living quarters such as an RV or residential vehicle (202). The bottom seal assembly (500) can include a jacket (514) connectable to a frame of the RV (505). The jacket (514) includes a main body (520), and a pair of wipes (528, 530) extending in a parallel configuration and directed toward a slide-out room floor (503). A bight portion (529) connects together the two wipes (528, 530) so as to form a gutter (534) for carrying off water and debris. A bottom wipe (524) extends outwardly from a base (522) of the main body (520). A spacer leg (532) extends inwardly from the jacket (514) and is used to appropriately position rollers (512) or wear bars (612), which can be utilized to smoothly move the room floor (503) between a raised and lowered position.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

### Field of the Invention

The invention relates to apparatus for facilitating the sealing of perimeters of slide-out rooms associated with recreational vehicles (RVs) and other mobile products, and, more particularly, to apparatus specifically providing bottom sealing functions for the slide-out rooms.

### Background Art

The general concept of employing means for facilitating sealing of joints in the construction of structures such as towable trailers, motorized recreational vehicles, buildings (particularly metal buildings) and similar structures is known in the prior art. For many of these types of structures, a substantially rigid frame is provided, which consists of structural support members, such as studs. The structural support members of the frame support and mount walls on the exterior of the frame. The walls are formed as pre-fabricated panels placed on the exterior of the frame formed by the structural support members. Corners are formed at the junctures of adjacent panels lying in different, but typically perpendicular planes. Also, typically, one of the adjacent panels is intended to overlap the adjacent support members by the thickness of the adjacent panel. In this manner, the adjacent panels lie in perpendicular planes which meet at a butt joint. Concepts associated with technologies associated with corner rail extrusions are disclosed in Goode, U.S. Pat. No. 7,735,891 issued Jun. 15, 2010.

Resilient seals are often placed along the abutting edges of parts, and one such application is found in the field of mobile living quarters having slide-out rooms. A seal is commonly placed along the interface between the slide-out room and the opening in the sidewall of the mobile living quarters to prevent water, debris, and excessive air drafts from entering the interior of the mobile living quarters from the outside. This seal often includes two sub-parts, a bulb seal and a wiper seal, each extending along a side of the opening. The bulb seal is usually placed on either the exterior edge of the sidewall or the interior edge of a flange portion of the slide-out room wall to form a resilient seal between the sidewall and the flange portion of the slide-out room when the room is closed. A separate wiper seal is usually placed along the edge of the sidewall and flexibly protrudes against the adjacent sidewall of the slide-out room so as to be in constant contact with the sidewall at all positions of the room between its open and closed positions. A typical example of such an arrangement can be seen in U.S. Patent Application Publication No. US 2002/0078634 A1, published Jun. 27, 2002. A problem with this type of seal arrangement is that the bulb seal and wiper seal must be mounted separately.

Another known seal arrangement used for the slide-out room includes a pair of bulb seals on opposite sides of a mounting portion, and a wiper seal protruding from an adjacent side of the mounting portion between the bulb seals, as disclosed in U.S. Pat. No. 6,048,016. The mounting portion is mounted to the edge of the sidewall of the mobile living quarters between the two opposite sides with a clip such that the wiper seal maintains flexible contact with the sidewall of the slide-out room. The two bulb portions contact one of two flange portions at either end of the slide-out room at both its open and closed positions to create a seal. This arrangement, however, may not be suitable for easy adaptation to be installed on different slide-out room configurations due to its unitary construction. Another problem is that, after long usage, the seal may disengage from the clip and fall off. If the seal falls off the clip, it can be difficult to access the clip for reinstalling the seal without taking the slide out room completely out of the wall.

Therefore, it would be desirable to have a multi-piece room seal that can be easily adapted for installation on different room configurations. It would also be desirable for the seal to be easily assembled on the exterior of the sidewall during installation to provide a single seal portion providing both a wiper seal for wiping against the sidewall of the slide-out room and a bulb seal for contacting the flange around the outside edge of the slide-out room when it is closed.

One prior art reference directed to the concepts associated with seals for slide-out rooms is Ksiezopolki, et al., U.S. Pat. No. 6,966,590 issued Nov. 22, 2005. For purposes of background art, the reference is duplicated in substantial part in the following paragraphs and in FIGS. 1-4. Referring now to prior art drawings in FIGS. 1-4, a mobile living quarters 10, such as a recreational vehicle, is shown having a slide-out room 12. Mobile living quarters 10 include a sidewall 14 having an opening 16 through which the slide-out room 12 shifts. Slide-out room 12 is of well-known form including an interior space generally defined by four sidewalls 18 and an end wall 20. Slide-out room 12 fits through opening 16 and extends perpendicular to sidewall 14 such that its end wall 20 is adjacent the sidewall of the mobile living quarters when the slide-out room is retracted and spaced from the sidewall when the slide-out room is extended. A flange 22 extends outwardly from the peripheral edge of end wall 20 of the slide-out room to overlap with sidewall 14 of the mobile living quarters when slide-out room 12 is retracted.

A resilient seal 24 is located along the periphery of opening 16 to prevent dirt, water, and other materials from passing from the exterior of the mobile living quarters 10 to its interior. Seal 24 may be made of any sufficiently resilient material such as thermoplastic elastomer. Seal 24 includes a generally flat mounting portion, or clip portion, 26 with a lip 27 fitted about the edge of sidewall 14 and a wiper seal portion 28 protruding transversely from the mounting portion toward sidewall 18 of the slide-out room. Wiper seal portion 28 is a flexible, generally planar section with its distal end opposite mounting portion 26 in resilient contact with sidewall 18 such that the wiper seal is flexed against the sidewall to maintain an effective seal with the sidewall at all times during extension or retraction of the slide-out room. Seal 24 furtherincludes a bulb seal portion 30 having a bulb part 33 and a clip part 35 which is slidably connected to mounting portion 26.

Mounting portion 26 includes oppositely extending, rail-like tabs 36, 38 which form a tongue 44 separated from the body of the mounting portion by a groove 46. Clip part 35 of bulb seal portion 30 includes tabs 32, 34 which form a groove 42 defined in part by opposing flanges 40. When mounting portion 26 and clip part 35 are connected together, tongues 44 fits into grooves 42. Tabs 32, 34, 36, 38 all extend lengthwise along seal 24 such that, once fitted together, bulb seal portion 30 may be slid along the length of mounting portion 26, and are flexible enough to allow them to snap past each other for assembly. Alternatively, clip part 35 of bulb seal portion 30 may be slid into mounting portion 26 from an end of the seal 24. Preferably, seal 24 is constructed such that mounting portion 26 is more rigid than wiper portion 28, and such that web 31 and tabs 32, 34 are more rigid than bulb part 33.

To install seal 24 onto the mobile living quarters about opening 16, pressure tape 52 having adhesive on both sides is applied to the exterior side of sidewall 14 along the edge of the opening where mounting portion 26 is to be attached. Mounting portion 26 is then located along the exterior edge of opening 16 in the sidewall 14 of the mobile living quarters by abutting lip 27 against the edge of the opening with tabs 36, 38 extending outwardly from the exterior side of sidewall 14 and wiper seal portion 28 extending toward sidewall 18 of the slide-out room. Next, pressure is applied to mounting portion 26 to press the mounting portion against pressure tape 52 to adhere the mounting portion to the sidewall. Fasteners 50 are then inserted through mounting portion 26 into sidewall 14 to firmly secure the mounting portion to the sidewall. Fasteners 50 are preferably screws driven through mounting portion 26 in the space between tabs 36, 38 so as to be hidden behind bulb seal portion 30 when in its mounted position. Next, clip part 35 of bulb seal portion 30 is mounted to mounting portion 26 by either snap fitting grooves 42 about tongues 44 or sliding the bulb seal portion at its groove about the tongue of the mounting portion from one end of the mounting portion. Bulb seal portion 30 is then adjusted in location along mounting portion 26 by sliding the bulb seal portion along the mated tongue 44 and groove 42 connection to its desired final location relative to mounting portion 26. Bulb seal portion 30 may be secured in its final position along mounting portion 26 by placing a fastener 48, preferably a screw, at an angle through only the internal web 31 of the bulb seal portion and the mounting portion near the end of the seal section. Fastener 48 preferably does not penetrate the bulb part 33 of bulb seal 30 in order to maintain a better seal with room flange 22. Bulb seal portion 30 may be subsequently replaced by removing fasteners 48 and installing a new section of bulb seal portion without having to replace the wiper portion.

Seal 24 may be easily adapted to fit to different slide-out room configurations by cutting to any necessary length. A variety of different comer configurations in the opening 16 may be easily adapted to by cutting the bulb seal portion 30 to a different length than the mounting portion 26, and the wiper seal portion 28 may be cut to a third length if necessary. A variety of different gaps between the mobile living quarter's sidewall 14 and the slide-out room sidewalls 18 may be easily adapted to by adjusting the lateral position of the mounting portion 26 relative to the sidewall 14 or trimming back the wiper seal portion 28. By mounting the mounting portion 26 and the bulb seal portion 30 to the exterior side of sidewall 14, subsequent repair and replacement of worn seal parts may be easily performed without having to remove the slide out room 12 from the opening 16 in wall 14.

In general, a number of the seal systems being used for slide-out rooms, utilize a semi-rigid plastic jacket as a “base element” to build a sealing system. Many of these known systems offer the relatively same physical configurations, with respect to the overall dimension of the wipe height, and bulb heights. However, a number of these known systems suffer some common disadvantages. For example, even with the use of a corner piece, many of these systems cannot provide a single, continuous seal around the perimeter of the slide-out room (in this case, the term “perimeter” means the sides and top of the slide-out room opening, excluding the bottom portion of the opening). That is, the known systems are required to have parts which will somehow splice together or simply overlap, but again do not provide for a single continuous seal.

With respect to a number of these known systems, the structure and function of the jacket instruction results in certain disadvantages. For example, the use of these jackets can result in the creation of a gap which is formed when there is an attempt to compress the jacket over the sidewall of an RV or some other vehicle. That is, the shoulders of the jacket are typically wider than the wall. Further, the legs of the jacket will “angle in” so as to create a compression of the edge of the sealing lip. Such a design essentially opens a gap from the shoulder, down to the sealing lip. Such a gap creates a potential leak path, when the same is installed. This is a substantial problem, particularly with respect to the vertical installation on the sidewalls.

To overcome some of the disadvantages associated with the afore-described systems, it is known to utilize a D-bulb for purposes of sealing all windows, baggage doors, entry doors and also on slide-out seals. The seals have been made of sponge EPDM, solid EPDM and thermoplastics such as TPE and TPV. Despite the material that these are made of, the D-bulbs have inherent flaws, such as the following:
1. The seal relies on one contact point. If not compressed enough, the seal will allow wind and water to “slide” over the bulb, as shown in FIG. 26.
2. The “D” profile doesn't always compress straight down and the bulb tends to shift. This can open up the seal for compression failure or cause accelerated wear.
3. If the “D” profile has to bend or follow a 90° turn to the side, the profile will pucker and distort, and not create a seal.
4. The “D” shape has to fold into itself to compress. If you try and use a higher durometer (i.e., hardness) to improve the wear, the harder the seal is to compress.
5. If the seal is not compressed all the way flat (i.e., line to line or top to bottom), the higher the wind and water force, the more likely the seal is to leak. The seal cannot accommodate for pressure change to a great extent.
6. On a vertical application, a “D” profile allows water to build up along the sealing edge and run back and forth until it finds a way to pass. That is, the radius top allows the water to flow to the sealing point when applied to an application where the profile will be vertical. The water can run over the radius and gather along the sealing edge and run back and forth until the water finds a way to seep.

To overcome some of the previously described disadvantages of using the “D” profile, a substantial advance in the art has been provided through the use of a “Sigma” shaped seal profile element. Such an element is described in the Inventor's own patent identified as Goode, U.S. Pat. No. 9,879,778 issued Jan. 30, 2018. This seal was developed to accommodate and correct many of the flaws of the D-bulb, by changing the profile and the manner in which the seal collapses. An example of the seal is shown in FIG. 29, with a seal having three sealing lips along a non-bonded first style. As an alternative, and as shown in FIG. 30, the sealing lips can be pressed in place. The lips can create additional scaling points, and the contoured sides can act as a gutter to divert water away from the sealing points. The contoured sides also act like a pneumatic seal (U-cup) when installed between two mating parts. When wind or water pressure increases, the contoured cup can be positively actuated, so as to energize the sealing lips. As the pressure increases, the quality of the seal also increases.

The contoured sides of the sigma seal allow the sealing edge to collapse straight down, and not rock from side to side, or cause distortion to the sealing area. The inside of the legs will have a wedge shape removed to promote correct compression, or the legs can also have situations to perform the same function. This design will allow for a higher durometer of material to be used, since the design allows for lower compression force and will extend the life of the seal.

The contoured sides also allow for the seal to make direct installation possible. When the seal has to bend around a corner or make a 90° turn, the contoured side will not kink or distort in a fashion like the D-bulb, and will still make a complete seal around the entire perimeter.

The sigma seal will also create a positive seal, even when not under full compression. The D-bulb works solely on complete compression and doesn't create much of a seal, unless compressed down to line to line. The contoured sides positively force the sealing lips with the sigma seal against the substrate, like a spring. As previously stated, when air or water pressure is added to the uncompressed, or compressed, seal, the seal positively actuates with more energy against both substrates. A contoured side to the seal can act as a gutter, when installed vertically. Water can flow into the cup or contour and run away from the sealing lips and exit correctly.

This application for patent is specifically directed to the use of bottom seals which are provided above the wheel wells of the RV. An example area where a bottom seal can be installed is an area which resides over the wheels of the RV, but is also recessed by 3 to 4 inches. Slide-out boxes can also exist in other areas, but the seal in accordance with the invention is typically used over the wheel area.

Within the prior art and the current marketplace, several types of bottom seals are known and have been developed for purposes of stopping water, light, debris and rodent penetration. However, a disadvantage of the known bottom seal systems is that they cannot be repaired without removing the slide-out room, or otherwise offering a complete sealing solution. An example of a known system for use of the bottom seal comprises a single bulb wipe which can be mounted vertically on the frame of the RV. However, such a seal, in a stand-alone configuration, is not complete and would need to be used in conjunction with a wipe to seal against the bottom of the slide-out floor. The seal would only be effective against the fascia or RAM bar. If the gap is larger than the bulb height, the seal is no longer effective. It would be advantageous to design a design which can bridge a varying gap.

Another configuration of a bottom seal which is currently known and marketed utilizes a bulb seal for the fascia or RAM bar, and also includes a single wipe. However, although this known configuration utilizes a single wipe design, it suffers from the same disadvantage of the afore-described design, in that this configuration cannot accommodate varying close heights.

A number of disadvantages associated with known bottom seal configurations can be summarized as follows:
The use of bulbs cannot, standing alone, accommodate varying close heights.
The use of a single wipe or no wipe whatsoever is not an effective design. A single wipe will allow water and debris to pass by. In fact, if the wipe is configured so that it does wipe the water off (assuming it is the correct size), the single wipe does not allow for adequate runoff Water management tends to be very poor and will allow water to pool up and eventually find a path into the unit.
The “single bulb” model requires a wipe to be installed in conjunction with the bulb configuration. This requires an additional step in production and SKU to buy.
Installers have to gauge the distance at which to install a wear bar or roller when using these designs.
The “single bulb, single wipe” design does not offer the installer any place to mechanically fasten the bottom piece of the unit. It can only be taped on.
With both designs, the slide-out room needs to be removed for the seal to be replaced. Such a requirement is a major cost for the owner or the OEM to pay to a dealer.
A single wipe cannot accommodate the application, if the slide-out floor changes height.
All of the jackets that are known for use of bottom seals are required to be used with corner cups to transition from the side wall to the bottom piece. These additional corner cups add cost and labor.

### SUMMARY OF THE INVENTION

In accordance with the invention, a seal assembly is adapted for use in combination with a mobile living quarters. The mobile living quarters include the slide-out room having a room interior and movable between a retracted, closed position and an extended, open position. At least one first side wall is formed in an exterior wall of the mobile living quarters, with the first side wall having a room opening formed therein. The first side wall further includes an exterior surface facing outwardly from a room interior, an interior surface facing inwardly, and an end section. An RV floor section is formed at the bottom of an interior of the mobile living quarters. The RV floor section is positioned at least in part below the slide-out room, and comprises a horizontal RV deck having an upper surface, a lower surface, and an end section opening outwardly from a side of the mobile living quarters.

The mobile living quarters further comprises an RV frame, extending below the RV deck and an underside section positioned below the RV deck.

The slide-out room formed at least in part by a first vertical room side wall, a second vertical room side wall opposing the first vertical room side wall, a room end wall facing outwardly and coupled to the first room side wall and second room side wall. A room floor is connected to the first and second room side walls and room end wall, so as to form the interior room of the slide-out room.

Further in accordance with the invention, the seal assembly includes a jacket connectable to the RV frame and having a main body. A pair of wipes extends in a parallel configuration relative to each other, and are directed toward the room floor. A bight portion extends between the lower ends of each of the pair of wipes. The jacket is structured and designed so as to be coupled to the RV floor section in a manner so that the area formed between the pair of wipes comprises a gutter for removing water and debris.

In accordance with one aspect of the invention, the pair of wipes includes a first wipe adapted to abut the room floor when the room floor is in either a recessed or flushed configuration. The wipes can be formed of differing heights, thereby accommodating both industry floor heights of raised and flushed configurations. One of the pair of wipes is characterized as an interior wipe of a first pre-determined length, and another of the pair of wipes is characterized as an exterior wipe having a second pre-determined length greater than the first pre-determined length. The seal assembly is adapted for use with means for supporting a sliding movement of the room floor relative to the RV floor section when the slide-out room is moved between the retracted position and the extended position. The means for sliding the slide-out room comprises a set of rollers or at least one wear bar.

In accordance with another concept of the invention, the seal assembly comprises a spacing leg extending outwardly from the seal body. The leg functions to control consistent positioning to the upper surface of the RV floor, and further provides for relatively accurate and repeatable wear bar or roller installation. The use of the spacing leg facilitates maintenance of the RV floor on the wear bar. Clearly, the use of the spacing leg facilitates maintenance of the RV floor on the roller installation.

The jacket can extend from the spacing leg of the seal assembly, along the RV floor to the room end wall, and then continuing so as to vertically encapsulate the room floor. In this manner, a seal is created.

In accordance with other concepts of the invention, the outwardly facing configuration of the jacket provides an area for mechanically fastening and also for alternate seal designs. The position of the jacket can also allow for the seal to be replaced, without having to remove the slide-out room. The assembly can also include a single bottom wipe extending outwardly from an end of the second leg of the jacket.

Further in accordance with the invention, the assembly can include a series of bottom wipes extending outwardly from an end of the second leg of the jacket. The bottom wipe can protrude from the second leg in a fashion so that it can accommodate all styles of slide-out room mechanisms and different close heights. The single bottom wipe can be structured so as to accommodate differing close heights and multiple applications. The jacket can be structured and designed so as to be capable of being run separately from the bottom wipe, and to allow dimensional changes. The jacket can be further structured and designed so as to function as a universal jacket, in that wipe lengths can be varied so as to accommodate any seal sizing requirements.

The jacket and the wipe length can be varied in size and dimension, so as to accomplish differing close heights and other specifications as desired by an RV manufacturer. The seal assembly can further include a wear bar which runs behind the spacing leg, so as to provide for all-in-one design. Further, the jacket can be trimmed along a 90° angle, and the spacing leg can be cut and a resultant vertical piece bent over the horizontal. In this manner, a corner is created and eliminates any need for a separate corner cup.

The additional material resulting from trimming the jacket along the 90° angle and extending out from under a corner can be fastened to a bottom of the RV floor, and utilized to completely close off the slide-out room. In this manner, further prevention is provided for intrusion by water, light, debris and rodents.

The gutter is formed between two wipes channeling water away from the inside mobile living quarters. The wipes are capable of being slid into place, and multiple height wipes can be made to accommodate all applications, while still being in use with the same jacket. Further, in accordance with other concepts of the invention, the pair of wipes can include a first wipe extending substantially parallel to the bight portion, and a second wipe parallel to the first wipe, and being positioned outwardly from the first wipe.

Further in accordance with the invention, a bottom seal is provided above the wheel wells of the RV vehicle. An area where the bottom seal can be installed is typically recessed by three to four inches, and can reside over the wheels of the RV. Slide-out boxes can also exist in other areas, but the seal in accordance with the invention is typically used over the wheel area.

Further in accordance with the invention, the typical corner cups can be eliminated, where the corner cups were typically in the front and behind the area to be sealed.

### BRIEF DESCRIPTION OF THE DRAWINGS

These and other aspects of the invention will be apparent from the following description, with reference to the accompanying drawings, in which:

FIG. 1 shows a prior art mobile living quarters with a slide-out room in an extended position surrounded by known seals;

FIG. 2 is a fragmentary detail perspective view of the room and seals of FIG. 1;

FIG. 3 is a fragmentary cross sectional view as seen along line 3-3 in FIG. 2;

FIG. 4 is a detailed cross section of the resilient seal parts separated from each other;

FIG. 5 is a sectional view of a prior art buildable seal assembly for slide-out rooms;

FIG. 6 is a prospective view of a mobile living quarters, having a slide-out room in a retracted position;

FIG. 7 is a perspective view similar to FIG. 6, but showing the slide-out room in an extended position, and surrounded in part by another known sealing system;

FIG. 8 is a perspective view of an RV vehicle similar to that of FIGS. 6 and 7, but showing the slide-out room in an fully extended position;

FIG. 9 is a front, sectional view of a known jacket in a standalone configuration, and showing D-bulbs in a position to be coupled to the jacket sections, and further showing a living hinge and associated wipes positioned between the jacket sections;

FIG. 10 is a sectional view showing the jacket in place, and taken along section lines 10-10 of FIG. 6;

FIG. 11 is a sectional view similar to FIG. 10, but showing the jacket in a position taken along section lines 11-11 of FIG. 7;

FIG. 12 is a further sectional view of the jacket with a D-bulb compressed against a wall of the slide-out room of the RV;

FIG. 13A is a sectional, standalone view of an embodiment of a prior art continuous snap in track system in showing the jacket being captured around a wall of the trailer body in the same manner as shown in FIG. 12;

FIG. 13B is a standalone and sectional view of a replacement wipe component;

FIG. 13C is a cross sectional view of a portion of the continuous snap in track assembly similar to FIG. 13A, but showing how the replacement wipe is inserted and captured by the jacket assembly;

FIG. 14 is a partial prospective and partial cross sectional view of a molded corner component for use with the continuous snap in track assembly;

FIG. 15 is a top view of a portion of the continuous snap in track assembly, showing the relative positioning of the corner component;

FIG. 16 is a prospective and a partially exploded view of a corner showing the relative positioning of the jacket and the molded corner piece;

FIG. 17 is an exploded, top view of the corner component with two jacket assemblies;

FIG. 18 is a bottom view of the corner component shown in FIG. 17;

FIG. 19 is an underside, prospective view of one of the full jacket assemblies, showing use with a living hinge, and further showing a structure of the jacket assembly prior to positioning on the RV;

FIG. 20 is a prospective view of a half section of the continuous snap in track assembly, showing a half section jacket component, and having a slide for positioning an LED tape light for providing aesthetic illumination for the assembly;

FIG. 21 is a cross sectional view showing the relative positioning of a half section of the jacket assembly as it is connected to a section of the RV body;

FIG. 22 is a cross section view similar to FIG. 21, but showing the half section being used with a replacement wipe;

FIG. 23 is a prospective and partially exploded view showing a pair of cooperating half section jacket components;

FIG. 24 is a partially cross sectional view of the cooperating jacket assemblies shown in FIG. 23, but showing their relative position as the half section jacket components are brought together in a overlapping configuration;

FIG. 25 is a cross sectional view similar to FIG. 24, but showing the half section jacket assemblies in a final conducting configuration, with the jacket legs also being secured to the RV wall;

FIG. 26 is a prior art view of a D-bulb previously used as a seal;

FIG. 27 is a cross sectional view of a prior art sigma seal showing its position relative to a wall or a static surface, having a top phalange;

FIG. 28 illustrates a U-cup;

FIG. 29 illustrates a prior art embodiment of a sigma seal showing the use of a tape or other high bond or transfer surface;

FIG. 30 illustrates another prior art embodiment of a sigma seal where a dart is used to press the seal into place;

FIG. 31 is a plan view, in partially schematic form, of the relative positioning of an RV floor, and showing the relative positioning of elements of a bottom seal in accordance with the invention;

FIG. 32 is a perspective view of a section of the bottom seal in accordance with the invention, and showing the concept that the body and base of the bottom seal can be cut at a 90° angle, and then folded so as to mate with the notched floor of the RV room, and with the seal configuration having the capability of replacement of corner cups;

FIG. 33 is a perspective view of a known corner cup which has been used with a known bottom seal configuration;

FIG. 34 is a further view of the section of the bottom seal shown in FIG. 32, but showing the bottom seal section at a right angle relative to the view shown on FIG. 32;

FIG. 35 is a perspective view similar to FIG. 33, but showing an opposing side of the use of a corner cup with the bottom seal;

FIG. 36 is a further view of the use of a corner cup with the bottom seal;

FIG. 37A is a perspective view of one embodiment of a bottom seal assembly in accordance with the invention, and showing a jacket having a lower replaceable configuration;

FIG. 37B is a second embodiment of a bottom seal assembly in accordance with the invention, with the second embodiment also having a replaceable jacket but with the lower part of the body having an angled section;

FIG. 37C is a further embodiment of a bottom seal assembly in accordance with the invention, but showing the main body as having a continuous configuration where replacement of the jacket would involve replacement of the entirety of the bottom seal assembly;

FIG. 38 is a perspective view of an RV vehicle, similar to the view shown in FIG. 1, but showing the recessed area under an RV room where the bottom seal assembly will be positioned;

FIG. 39 is a view similar to FIG. 38, but showing an end of a bottom seal assembly in accordance with the invention, with the end being identified with circle 34, which corresponds to the portion of the bottom seal assembly embodiments shown in FIG. 34, and with the RV room in an extended position;

FIG. 40A is a sectional end view of the bottom seal assembly embodiment shown in FIG. 37A, and showing the seal assembly in use with rollers and showing the relative positioning of the seal assembly with respect to the RV deck, frame and bottom board, with a board clip being used as a component of the seal assembly;

FIG. 40B is a sectional end view similar to FIG. 40A, but showing the relative positioning of the interior, exterior and bottom wipes as the slide-out room moves from a retracted position to an extended position;

FIG. 40C is a further sectional end view similar to FIG. 40A, but showing the slide-out room being further extended outwardly to its fully extended position, and illustrating the abutment of the rollers with a chamferred section of the room floor;

FIG. 40D is a sectional end view of the seal assembly, similar to FIG. 40A but showing the use of wear bar in place of rollers, and further showing the slide-out room in a substantially intermediate position between extended and retracted positions;

FIG. 40E is a sectional end view similar to FIG. 40B, showing the use of a wear bar and with the slide-out room being substantially extended so that the interaction between the war bar and the chamferred section of the room floor has caused the room floor to substantially drop to a vertical position substantially corresponding to the position when the slide-out room is in the fully extended position; and

FIG. 40F is a sectional end view of the bottom seal assembly illustrated in FIG. 37B, but showing the seal assembly in a stand-alone configuration.

### DETAILED DESCRIPTION

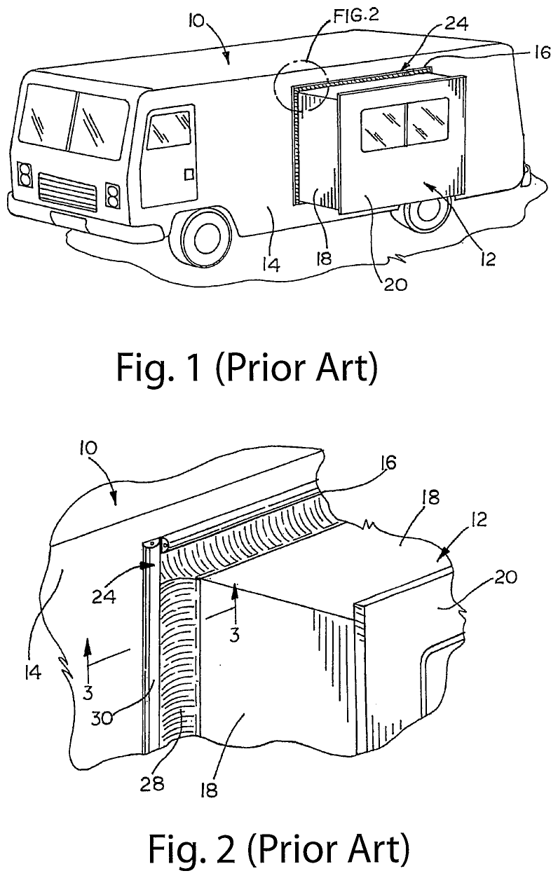

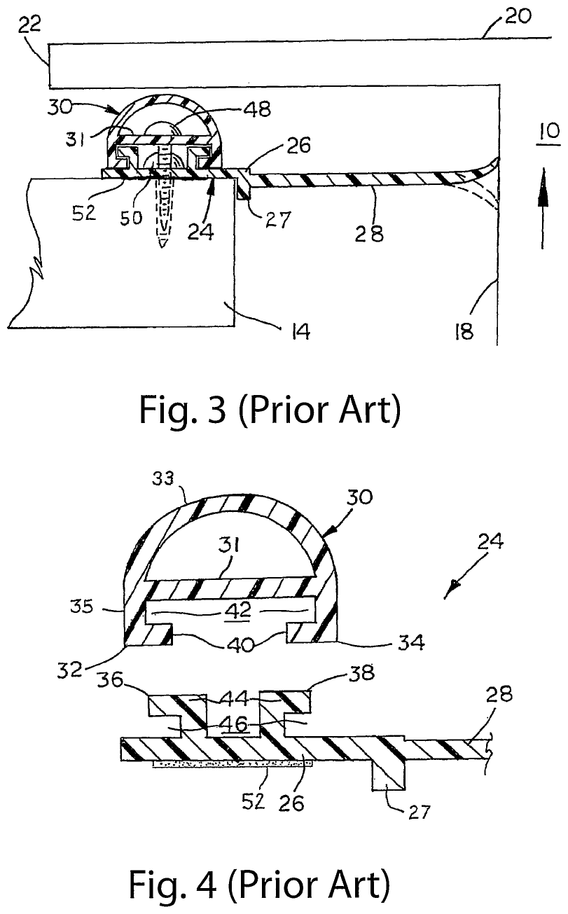

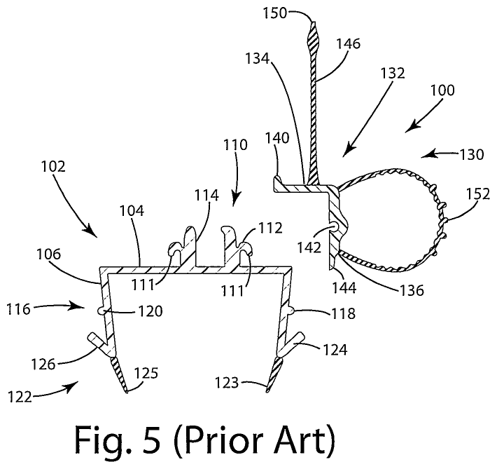

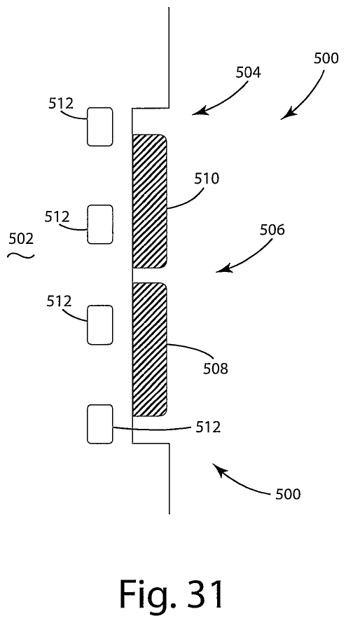

The principles of the invention are disclosed, by way of example, in a bottom seal system 500 described in subsequent paragraphs herein and illustrated in FIGS. 31, 32, 34, and 36-40F. Prior to description of embodiments of the invention, the following paragraphs describe prior art seal systems associated with RV slide-out rooms. A basic slide-out system is illustrated in FIGS. 1-5. This seal assembly is the subject of the inventor's own U.S. Pat. No. 9,834,129 entitled, “BUILDABLE SEAL FOR SLIDE-OUT ROOMS, issued Dec. 5, 2017. The following paragraphs describe this buildable seal assembly 100 with respect primarily to FIG. 5.

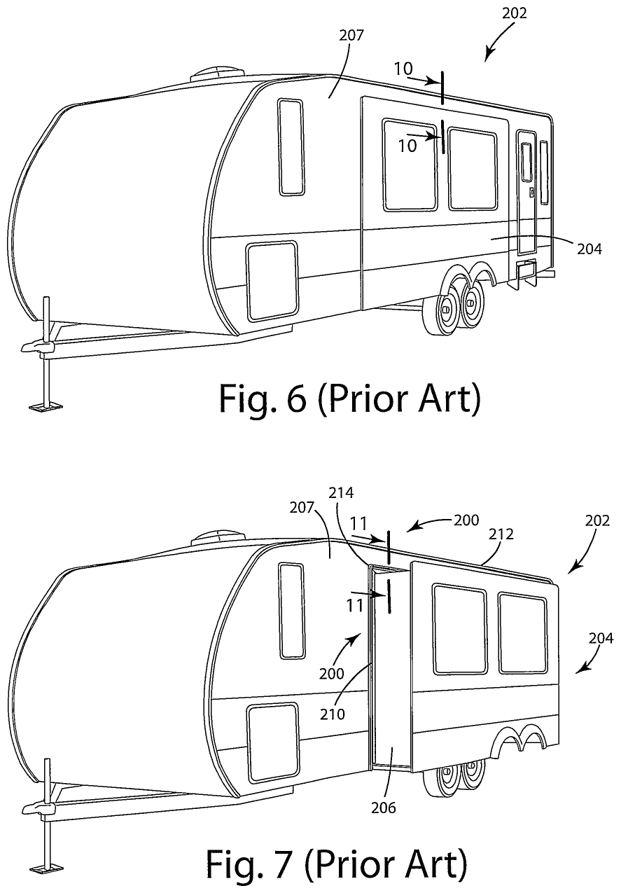

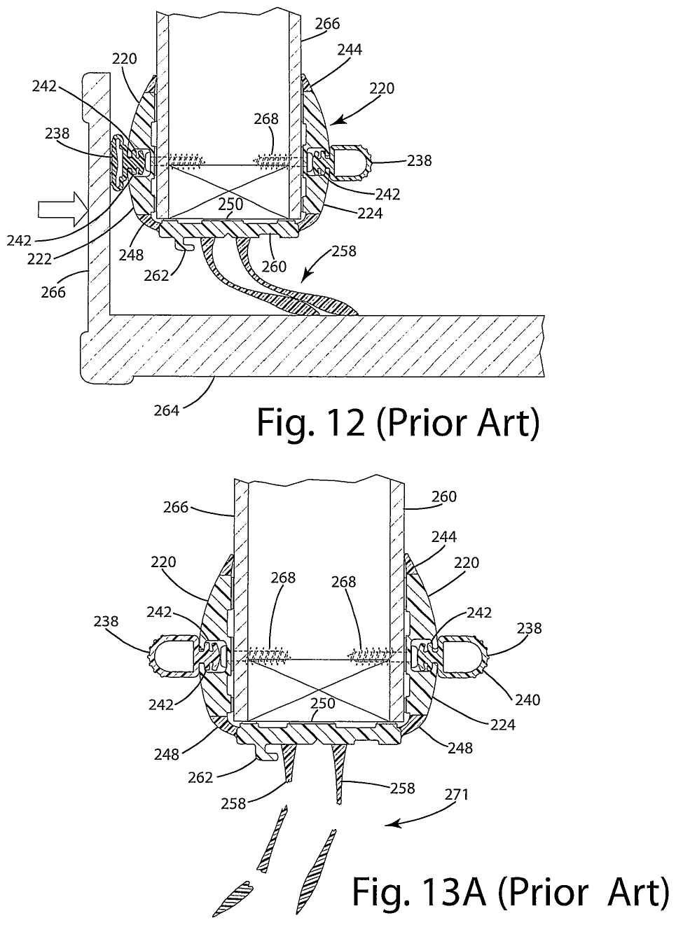

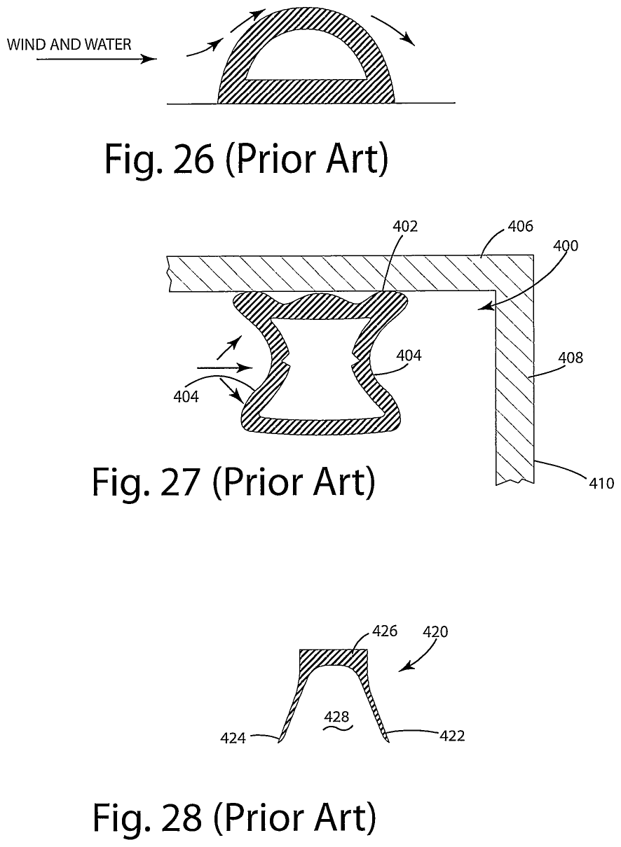

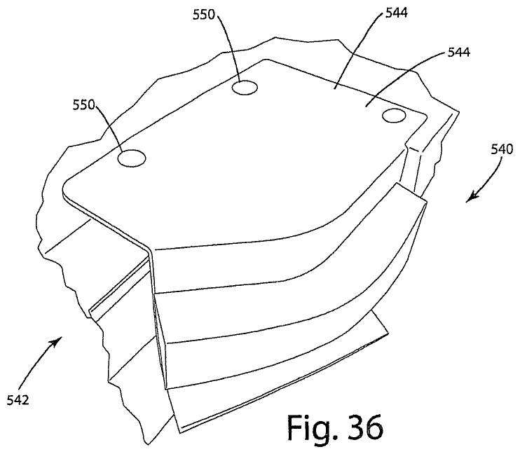

Following the description of the buildable seal assembly, a continuous snap in track system is described with respect to FIGS. 6-25. This system is the subject of the inventor's own U.S. Pat. No. 10,065,553 issued Sep. 4, 2018. An advance of the art was previously developed by the inventor and is directed to the use of a “sigma seal” profile which uses three sealing lips so as to provide additional sealing points for the seal assemblies as used with the RV mobile living quarters. The sigma seal profile is also the subject of this inventor, and is covered in U.S. Pat. No. 9,879,778, and issued Jan. 30, 2018. The sigma seal profile is described in subsequent paragraphs herein, and illustrated in FIGS. 26-30. Following the description of these known systems as developed by the inventor, the manner in which the current invention is different from the known systems, and embodiments of the current invention comprising a bottom seal system for RV living quarters with slide-out rooms are described. The use of a corner cup for bottom seals is also disclosed herein, and illustrated in FIGS. 33, 35, and 36. As earlier stated, the embodiment of bottom seals in accordance with the present invention are illustrated in FIGS. 31, 32, 34, and 37-40.

The buildable seal assembly 100 is used in association with a jacket 102 as also shown in FIG. 5. The buildable seal assembly 100 can be characterized as a three-piece design which allows the user to snap the seal assembly into place, without the requirement of any type of sliding movement. The buildable seal assembly 100 is illustrated in FIG. 5 as showing the use of one bulb 152 and one wiper 146. However, seal assembly 100 is buildable in that multiple wiper components 146 and/or multiple bulbs 152 can be utilized. An advantage is that the OEM can choose the particular design, in terms of the number of bulbs and wiper components, yet still retain use of the same jacket 102. Still further, not only can the number of bulbs and wiper components be modified, but various lengths of wipers and sizes of bulbs can also be utilized.

Turning specifically to FIG. 5, the jacket 102 is shown in a “stand alone” version, and would be connected to the sidewall and slide-out room of a conventional RV or similar mobile equipment. The jacket 102 includes a first side 104. The first side 104 includes, extending from one surface therefrom, a pair of insert tabs 110. The insert tabs 110 include a first insert tab 112, and a second insert tab 114. The insert tabs are positioned in an opposing relationship and are utilized to capture nubs 140 of the buildable seal assemblies 100. The insert tabs 110 can each have an inwardly extending hook 111 for purposes of capturing the nubs 140.

In addition to the foregoing elements, the jacket also includes a first leg 106 which extends at an angle from one end of the first side 104 of the jacket 102. Correspondingly, a second leg 108 extends at an angle from the opposing end of the first side 104 of the jacket 102. It should be noted that the legs 106 and 108 of the jacket 102 will not necessarily be at right angles relative to the side 104 of the jacket 102, but instead may actually be angled inwardly greater than 90°, so as to apply a compressive force to the sealing lips 123 and 125. That is, this angling feature essentially provides the jacket 102 to be positively actuated with respect to the lips 123 and 125.

Positioned on the first leg 106 and second leg 108 are a pair of locator/retention lips 116. The locator/retention lips 116 include a first locator/retention lip 118 positioned on the outer side of the first leg 106, and a second locator/retention lip 120 positioned on the outer side of the second leg 108. The retention lips 116 are utilized in cooperation with the buildable seal assembly 100 to capture the seal assembly 100 in a “snap-in” relationship.

In addition to the locator/retention lips, the jacket 102 also includes a pair of retention tabs 122. The retention tabs 122 act so as to provide for retaining of one leg of the seal assembly 100. It is apparent that if two seal assemblies are utilized, then both retention tabs 122 would be used simultaneously. The retention tabs 122 comprise a first retention tab 124 located on the second leg of the jacket 102, and a second retention tab 126 located on the first leg 106 of the jacket 102. Positioned inwardly from the ends of the first and second legs 106, 108 of the jacket 102 are a pair of compression lips 123 and 125. Compression lip 123 extends inwardly from the end of the first leg 106 of jacket 102, while the other compression lip 125 extends inwardly from the end of the second leg 108 of the jacket 102. The compression lips 123, 125 serve to maintain position and seal of the jacket 102.

The buildable seal assembly 100 further includes a snap-in seal assembly 130, as also shown in FIG. 5. Multiple seal assemblies 130 may be utilized with the jacket 102. With reference to FIG. 5, the seal assembly 130 includes a right-angled seal element 132. The right-angled seal element 132 comprises the basic seal element which will be coupled to the jacket 102 in a snap-in configuration. The right-angled seal element 132 includes a pair of legs, identified in FIG. 5 as side leg 134 and angled leg 136. Each of the legs 134, 136 is configured at a 90° angle relative to the other leg. At the distal end of the side leg 134 is a nub 140. The nub 140, when the assembly 130 is coupled to the jacket 102, will be positioned so as to essentially be captured under the lip 111 of the first insert tab 112. Alternatively, the seal assembly 130 can be configured so that the nub 140 would be captured under the lip 111 of the second insert tab 114.

Positioned on one side of the angled leg 136, and essentially centered with respect thereto, is a slot 142. The slot 142, with the right-angled seal element 132 being resilient, is configured so as to capture the locating/retention lip 118 in a snap-in configuration.

Further with respect to the right-angled seal element 132, positioned at a distal end of the angled leg 136 is a tab 144. When assembled, the tab 144 is captured within the first retention tab 124, or the second retention tab 126. This configuration serves to stabilize the snap-in seal assembly 130 when coupled to the jacket 102.

The buildable seal assembly 100 can also include a wiper component 146 as further shown in FIG. 5. The wiper component 146 is flexible in nature, and facilitates the maintaining of an effective seal with the side wall (not shown in FIG. 5) at all times during extension or retraction of an associated slide-out room (not shown). The wiper component 146 includes an elongated wiper 148. Positioned at the distal end of the elongated wiper 148 is a bead 150. With respect to connection of the wiper component 146 to the right-angled seal component 132, the wiper component 146 can be molded onto the right-angled seal element 132 in line, while the same is being extruded.

In addition to the foregoing components, the snap-in seal assembly 130 can include a bulb 152 having a configuration as shown in cross-section in FIG. 5. It should be noted that the right-angled seal element 132 can be used with or without the wiper component 146, and also with or without the bulb 152.

Turning to the various embodiments of a continuous snap in track system, a continuous snap in track system 200 is initially illustrated in FIGS. 6-13C. The track system 200 is illustrated in FIGS. 6-8 as being used with a residential vehicle or “RV” 202. With the exception of the track system 200, the RV 202 is conventional in design and well known throughout the tourism industry. As with many RV's, the RV 202 is equipped with a slide-out room 204 protruding through at least one sidewall of the RV. The slide-out room 204 includes an outer room wall 206. When the slide-out room 204 is in a retracted position (as shown in FIG. 6), the outer room wall 206 is essentially flush with an RV side wall 207.

Through conventional means, the slide-out room 204 can be released from its retracted position and be moved outwardly, so as to provide for additional interior RV space. FIG. 7 illustrates the slide-out room 204 in an intermediate, extended position. As illustrated in FIG. 7, the slide-out room 204 includes room sidewalls 206 (only one of which is shown in FIG. 7).

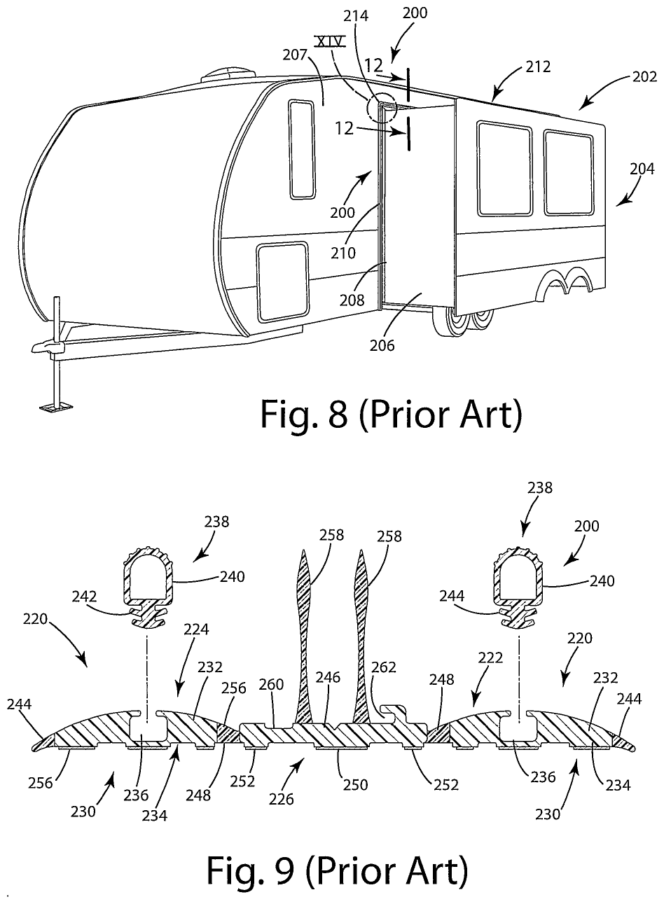

FIG. 8 illustrates the slide-out room 204 in a fully extended position. As illustrated in FIG. 8, as the slide-out room 204 is extended, a gap 208 is apparent between the slide-out room wall 206 and the RV sidewall 207. To protect against water damage and to essentially seal the various gaps 208 around the perimeter of the slide-out room 204, seal systems can be utilized, such as those described in prior paragraphs hereof. In this particular instance, the seal is in the form of a continuous snap and track system 200. The snap in track system 200 includes a vertical seal assembly 210 and a horizontal seal assembly 212. The horizontal seal assembly 212 will run along the top wall or ceiling (not shown in FIG. 6, 7 or 8). As described in subsequent paragraphs herein, the vertical seal assembly 210 and horizontal seal assembly 212 are coupled together through the use of a corner seal assembly 214.

The continuous snap in track system 200 will now be described, primarily with respect to FIGS. 9-19. With reference first to FIG. 9, the snap in track system 200 includes a pair of jacket assemblies 220, comprising a first jacket assembly 222 and a second jacket assembly 224. The jacket assemblies 220 are coupled together through the use of a flexible hinge assembly 226. Each jacket assembly 220 includes a jacket leg 230 having a cross-sectional configuration as illustrated in FIG. 9. As shown therein, each jacket leg 230 has an arcuate main body 232 with respect to an outer surface of each of the legs 230. Each leg 230 also includes a straight edge 234. Positioned in the outer arcuate edge of each of the jacket legs 230 is a D-bulb channel 236. The D-bulb channels 236 are adapted to receive D-bulb components 238, shown in a partially exploded configuration in FIG. 9. Each D-bulb component 238 includes a D-bulb 240 having the cross-sectional configuration shown in FIG. 9. Integral with the D-bulb 240 is a dart component 242. The D-bulb component 238 is adapted to “snap in” to the D-bulb channel 236 of each jacket leg 230, through the insertion of the dart 242.

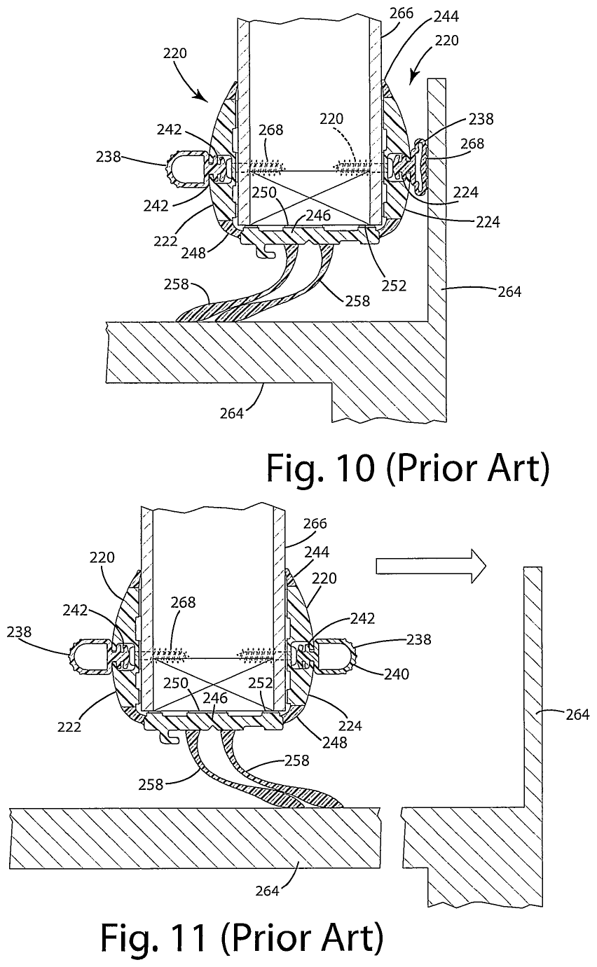

As further shown in FIG. 9, each of the jacket legs 230 includes an outer sealing lip 244. As illustrated in FIGS. 10-13C, the sealing lip 244 can cooperate with corresponding lips on corner pieces (as described in subsequent paragraphs herein), so as to offer a significant performance advantage by eliminating the need for any type of a caulking process. The outer sealing lip 244 will also assist in forming an appropriate water shed.

With further reference to FIGS. 9-13C, snap in track system 200, as earlier stated, includes a flexible hinge assembly 226. The flexible hinge assembly utilizes living hinges which can accommodate differences in wall width. The living hinge assembly 226 creates a type of pleat.

The living or flexible hinge assembly 226 includes a main hinge body 246, with the hinge body 246 having the cross-sectional configuration as particularly shown in FIG. 9. Coupled to the hinge body 246 by any suitable means are a pair of hinge components or living hinges 248. The living hinges 248 derive for flexibility and function in accordance with teachings previously described herein. The living hinges 248 are each coupled to opposing ends of the jacket legs 230. For purposes of securing and supporting the living hinge assembly 228 a central hinge pad 250 is secured to the central portion of the hinge body 246. Correspondingly, outer hinge pads 252 are secured to outer portions of the main hinge body 246.

For purposes of appropriately securing and positioning the jacket legs 230, each of the legs 230 includes a central jacket tape 254. Such tape can be one of a number of different commercially available tapes, such as 3M DHB (high bond tape). Correspondingly, each of the jacket legs 230 includes a pair of jacket pads 256. The jacket pads 256 can be constructed of a number of different types of materials, such as 30 Duro TPV. The jacket pads 256 assist in positioning and maintaining the position of the flexible hinge assembly 228.

In addition to the foregoing elements of the flexible hinge assembly 228, the assembly 228 also includes a pair of wipes 258. The wipes are secured to one wall of the main hinge body 246. Also positioned on the same side of the main hinge body 246 is a recessed tape area 260, and a retention clip 262. The purpose of these elements, related to replacement of wipes, will be explaining in the following paragraphs.

FIG. 10 illustrates the continuous snap in track system 200 as it is positioned and captures a trailer wall 266. Also, FIG. 20 illustrates the position of the snap in track system 200 relative to the slide wall 264. The configuration shown in FIG. 20 would correspond to the position of the slide room shown in FIG. 6, with the slide room in a fully retracted position. Correspondingly, FIG. 11 is an illustration showing the continuous snap in track system 200 positioned on the trailer wall 266, and with the slide room being moved outwardly so as to partially extended, such as is shown in FIG. 7. Correspondingly, FIG. 11 is a view of the continuous snap in track system 200 with the slide room in a fully extended position, such as is shown in FIG. 8. It should be noted that the jacket legs 230 are secured to the trailer wall 266 through a pair of bolts, self-tape in connecting screws or similar connecting means 268 which extend through apertures 270. It should also be noted, for example, with respect to FIG. 10, that one of the D-bulbs 240 is actually compressed against the slide wall 264 when the slide room is in the retracted position. Correspondingly, when the slide room is in the fully extended position, the other of the pair of D-bulbs 38 is compressed against a slide wall 264. Further, FIGS. 10-12 show the relative positioning of the wipes 258 as the slide room is moved from a retracted to an extended position.

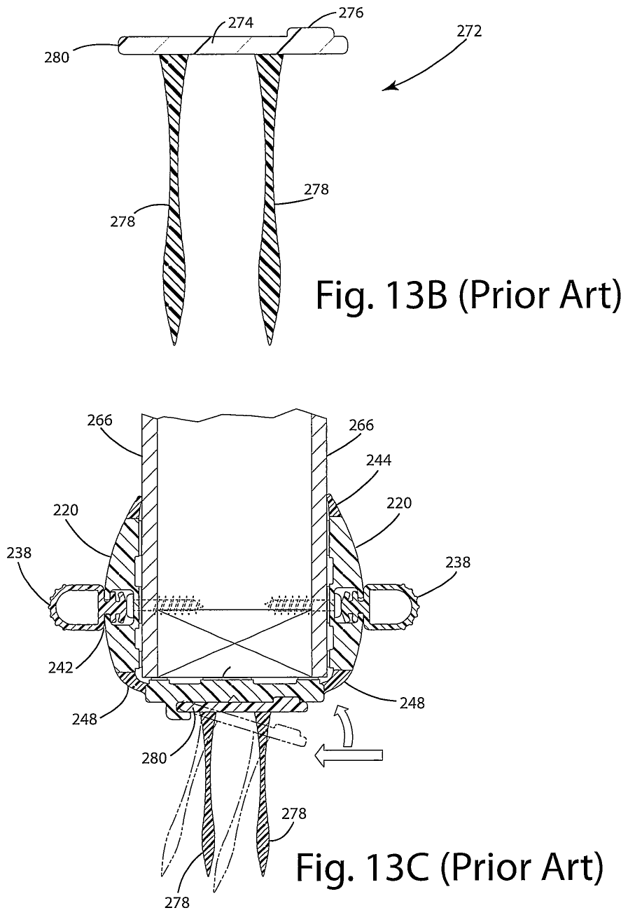

FIG. 13A illustrates a situation where the wipes 258 have been broken or otherwise worn beyond their useful lives. In such a case, and in accordance with another aspect of the invention, a replacement wipe assembly 272 is provided. A cross-sectional configuration of a replacement wipe assembly 272 in accordance with the invention is illustrated in FIG. 13B. As shown therein, the replacement wipe assembly 272 includes a replacement wipe base 274 having the cross-sectional configuration shown in FIG. 13B. Secured to one side of the replacement wipe base 274 is a replacement wipe tape 276. The replacement wipe tape 276 can be any of a number of commercially available tapes, such as 3M VHB.

The replacement wipe assembly 272 also includes a pair of parallel wipes 278 which can be made substantially identical to the original wipes 258. To utilize the replacement wipe assembly 272, the assembly is coupled to the continuous snap in system 200 as shown in FIG. 13C. Specifically, one edge of the replacement wipe assembly 272 is designated as edge 280. Such designation is also shown in FIG. 13B. With the replacement wipe assembly 272 positioned at an angle relative to the continuous snap in track system 200, the user can essentially slide the retention edge 280 into the slot formed by the previously described retention clip 262. When the retention edge 280 is sufficiently positioned within the retention clip 262, the replacement wipe assembly 272 can be moved as shown by the arrows of FIG. 13C, so that the tape 276 is positioned within the recessed tape area 260. In this manner, replacement wipes can be readily and easily assembled for substitution.

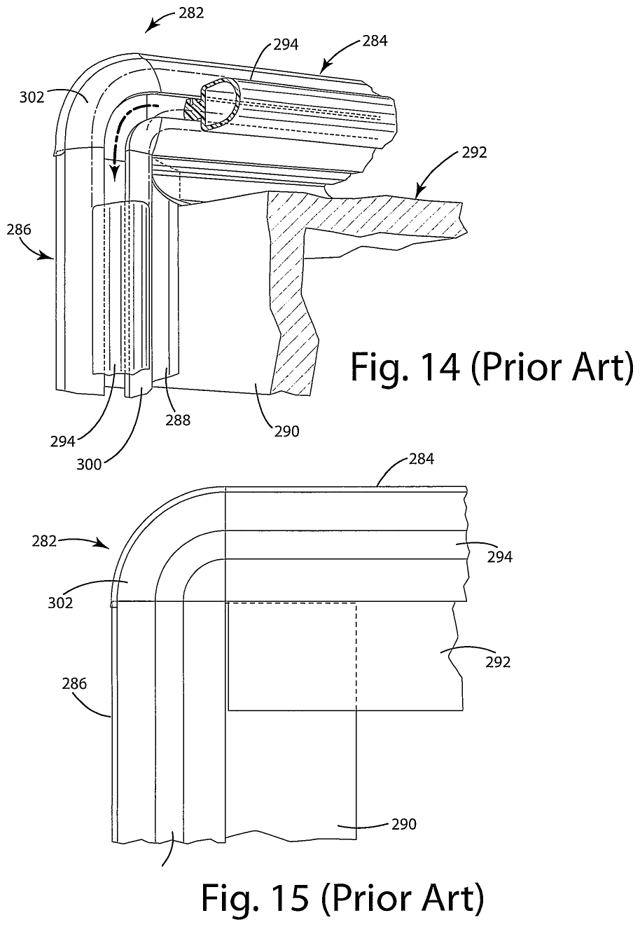

In addition to the foregoing features in accordance with the invention, continuous snap in track systems in accordance with the invention include a system which employs a molded corner assembly with a lip 282. The molded corner assembly 282 is described in the following paragraphs, and illustrated in FIGS. 14-18. With reference to these drawings, the molded corner assembly 282 is formed so as to provide a seal and a path of travel for a D-bulb assembly in a slide-out configuration. With this configuration, and with co-axial D-bulb channels, an OEM will be able to use one continuous piece of D-bulb assemblies, without any breaks. This configuration will allow the OEM to build whatever size D-bulb is needed, and not have to worry about inventory of additional jackets. Further, the molded corner tabs of the channel pieces will fill the voids of the extruded jacket legs, and will prevent water intrusion. The corner assemblies will also complete a finished product, and complete the track for the D-bulb to be inserted.

Turning to FIGS. 14-18, the molded corner assembly 282 includes a first continuous snap in assembly 284, and a second continuous snap in assembly 286, positioned perpendicular to each other are provided with each track assembly. As shown in FIG. 14, the continuous snap in track assembly is positioned adjacent a slot in wall 290, a slide room top 292. D-bulb channels 294 extend through both of the track assemblies 284, 286, as well as through the corner assembly 282.

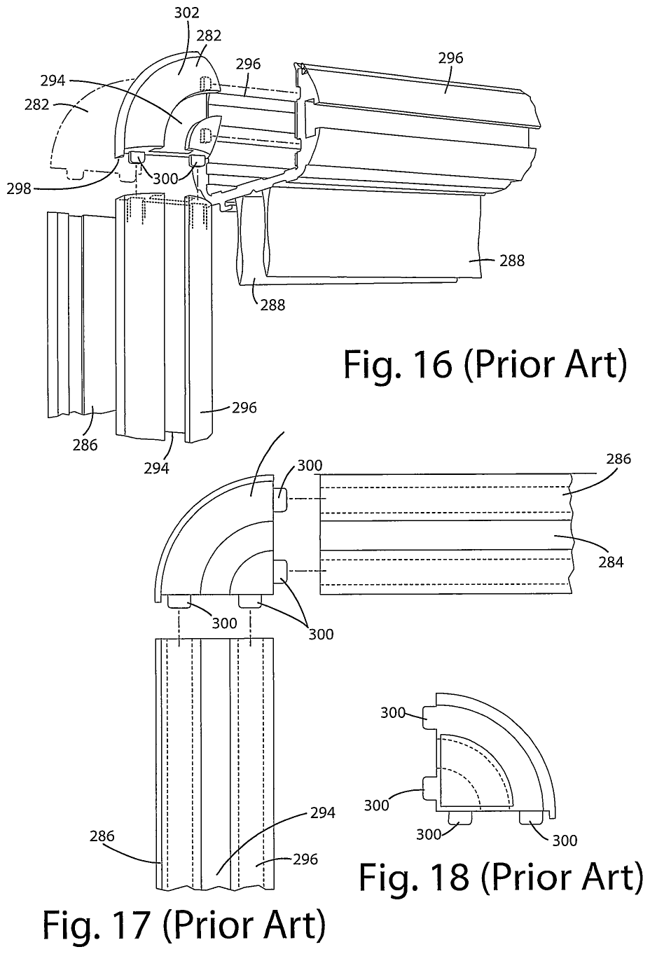

Each of the continuous snap in track assemblies 284, 286 include what can be characterized as jacket assemblies 296 shown in FIG. 16. Positioned at the ends of the corner assembly 282 are a pair of water shed tabs 298. As earlier mentioned, with the use of full outer lip seals on the jackets and on the corner assembly 282 offers a significant performance advantage by eliminating the need for any type of caulking or similar securing process. The outer sealing lips will also create a corrected water shed.

FIG. 16 further illustrates the use of two of the corner assemblies 282, each connected to different jacket legs of different jacket assemblies. Connection is made through the use of connector tabs 300 which are positioned within the arcuate bodies 302. As particularly shown in FIG. 16, two of the corner pieces can be used, with each corner assembly 282 being fitted within a pair of the jacket legs associated with the snap in track assemblies 284, 286. As earlier stated, the molded corner assemblies 282 will fill the voids of the extruded jacket legs, and will prevent water intrusion. The corner assemblies 282 will also complete a “finished” look and also complete the track for the D-bulb to be inserted. FIG. 17 and FIG. 18 also show two representations of the molded corner assembly with lip 22.

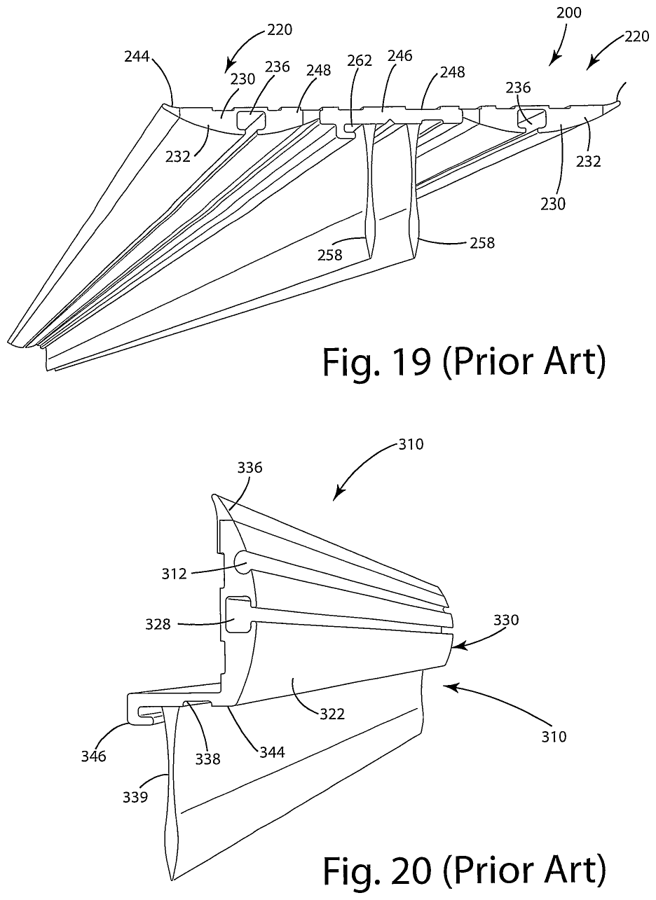

FIG. 19 is a perspective view from an underside of the full double jacket living hinge continuous snap-in assembly.

FIG. 20 is an embodiment of a half section continuous snap-in assembly, showing a perspective view of a tape light aperture 312 extending through the jacket in a longitudinal direction. The tape light aperture 312 is adapted to be used with a tape light or other type of LED lighting device for purposes of both functional use and aesthetic appearance.

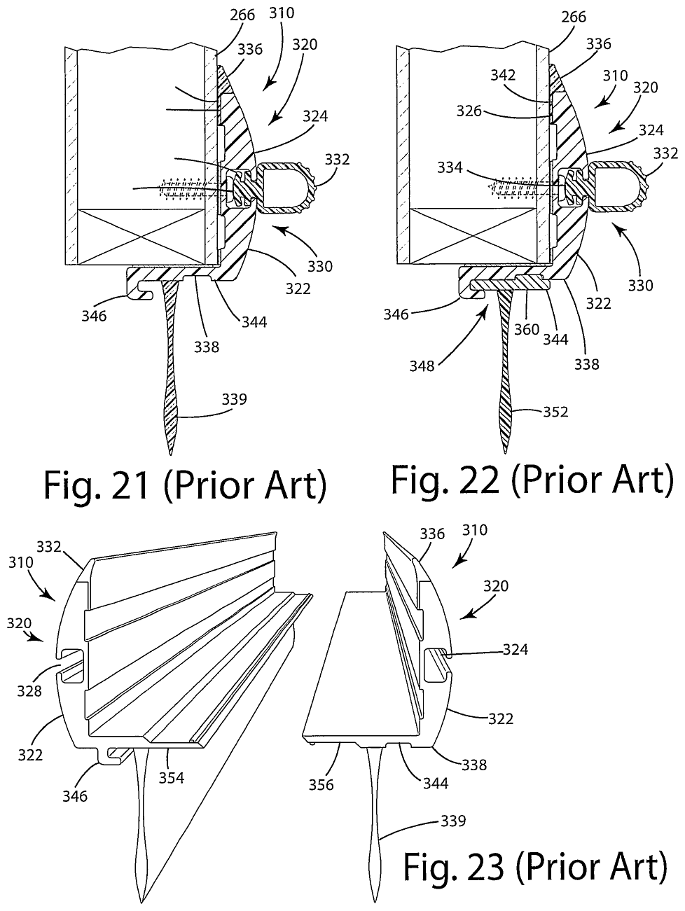

A further configuration for the continuous snap-in track assemblies is illustrated in FIGS. 21 and 22. Therein, a snap-in track assembly 310 is illustrated, which could be characterized as a half section assembly. As apparent from the drawings, the half section track assembly 310 includes only a single jacket and a single wipe. In describing the components of the assembly 310, these components will not be described in context detail, since they are functionally and structurally similar to components of the previously described track assembly. With reference to FIGS. 21 and 22, the half section assembly 310 includes a jacket assembly 320. The jacket assembly 320 is adapted to be secured along one side of a trailer wall 266. The jacket assembly 320 includes a single jacket leg 322. The jacket leg 322 includes an arcuate main section 324. Opposing the arcuate main section 324 is a straight edge 326. The straight edge 326 is adapted to be adjacent to the side wall 266 of the trailer wall.

The jacket assembly 320 also includes a D-bulb channel 328. A series of D-bulb components 330 function with the D-bulb channel 328. The D-bulb components 330 comprise a D-bulb 332, as previously described herein, as well as a previously described dart component 334. The dart component 334 can be adapted to be “snapped” into the D-bulb channel 328.

Referring to components separate from the D-bulb components 330, the jacket light 322 includes an outer sealing lip 336 positioned at a terminal end of the jacket 322. The outer sealing lip 336 functions as previously described herein with respect to other snap-in track assemblies.

In addition to the jacket assembly 320, the half section assembly 310 also includes a wipe leg 338. The wipe 338 is preferably integral with the jacket leg 322 and extends perpendicular to the elongated direction of the jacket leg 322. As with previously described jacket assemblies, the half section snap-in assembly 310 also allows for the use of replacement wipes. Specifically, FIG. 21 illustrates what can be characterized as an original wipe 339 connected to the wipe leg 338. In contrast, assuming that the wipe 339 has been damaged in some manner, the replacement wipe assembly 348 can be utilized, as shown in FIG. 22. The replacement wipe base 350 can be maneuvered so as to be captured under the retention clip 346 and be captured by tape which is secured to the replacement wipe base 350 and maneuvered so as to be in position with the recessed tape area 344. In this manner, a replacement wipe can be replaced, without requiring substantial complexity, complex tools or the like.

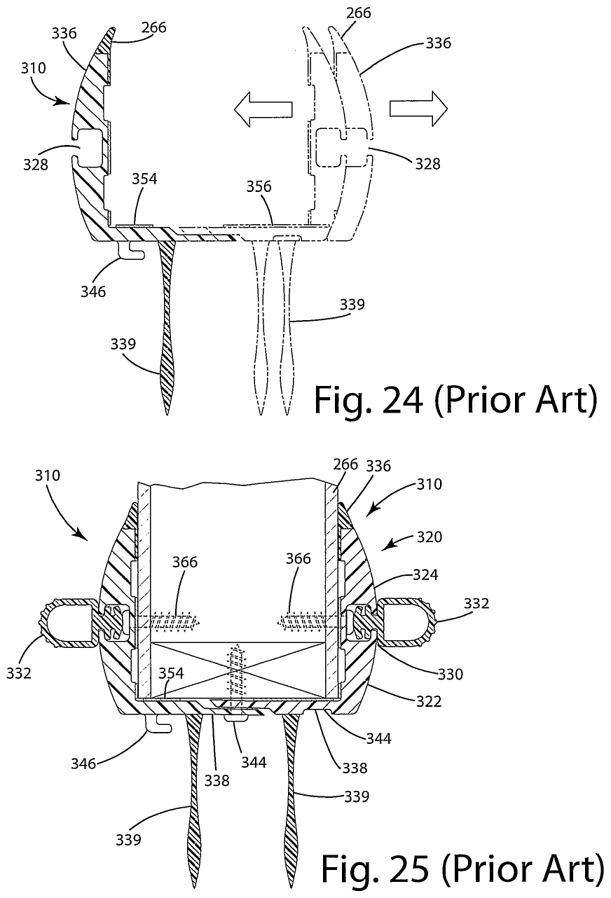

A variation with respect to the half section snap-in assemblies 310 illustrated in FIGS. 21 and 22 is further illustrated in FIGS. 23, 24 and 25. In these drawings, a pair of half section snap-in track assemblies 310 are illustrated. The assemblies 310 are substantially similar to the assembly 310 illustrated in FIGS. 21 and 22. However, the assembly 310 shown in FIGS. 23-25 is equipped with a first chamfered leg 354. Correspondingly, the other of the assemblies 310 illustrated in FIGS. 23-25 is equipped with a second chamfered leg 356. The two chamfered legs 354, 356 cooperate with each other so as to have interlocking chamfered legs. FIG. 23 illustrates the legs as they would be positioned to be coupled to each other. FIGS. 24 and 25 illustrate the legs as they are interlocked together (in intermediate view in FIG. 24) and in a final position (shown in FIG. 25). Another distinction between the chamfered legs is the concept that one of the legs 354 includes a retention clip 346, while the other leg includes the recessed tape area 344. If desired, connecting bulbs can be positioned at the terminal ends of the chamfered legs for purposes of further securing together of the legs. Still further, connecting means in the form of a screw or the like 366 can be utilized to couple the chamfered legs together.

A D-bulb is one solution for sealing all windows, baggage doors, entry doors and also on slide-out seals. The seals have been made out of sponge EPDM, solid EPDM and thermoplastics such as TPE and TPV. Regardless of the material that they are made of, the D-bulb can have inherent flaws, as follows:

1. The seal relies on one contact point. If not compressed enough the seal will allow wind and water by. (illustrated on “d-bulb” picture)

2. The “D” profile doesn't always compress straight down and the bulb tends to shift. This can open up the seal for compression failure or cause accelerated wear.

3. If the “D” profile has to bend or follow a 90° turn to the side the profile will pucker and distort and not create a seal.

4. The “D” shape has to fold into itself to compress and if you try and us a higher durometer (hardness) to improve the wear the harder the seal is to compress.

5. If the seal is not compressed all the way flat (line to line or top to bottom) the higher the wind and water force the more likely the seal is to leak. The seal can't accommodate for pressure change well.

6. On a vertical application a “D” profile allows water to build up along the sealing edge and run back and forth until it finds a way passed. Another way to put it is that the radius top allows the water to flow to the sealing point when applied to an application where the profile will be vertical. The water can run over the radius and gather along the sealing edge and run back and forth until it finds a way in.

To get around the issues stated above the “Sigma Seal” profile can accommodate and correct all of the issues by changing the profile and how the seal collapses.

The Sigma Seal (SS) has three sealing lips along the non-bonded (style 1) or pressed in place (style 2) side. The three sealing lips create additional sealing points and the contoured sides act as a gutter to divert water away from the sealing points. The contoured sides also act like a pneumatic seal (u-cup) when installed between to mating parts. When the wind or water pressure increases it positively actuates the contoured cup and energizes the sealing lips. The higher the pressure the greater the seal.

The contoured sides of the SS allow the sealing edge to collapse straight down and not rock from side to side or cause distortion to the sealing area. The inside of the legs with have a wedge shape removed to promote correct compression or the legs can also have striations to perform the same function. This design will allow for a higher durometer of material to be used since the design allows for lower compression force and will extend the life of the seal.

The contoured sides also allow for the seal to make direction installation possible. When the has to bend around a corner or maker a 90° turn the contoured side will no kink or distort in a fashion like the D-bulb does and will still make a complete seal the entire perimeter.

The SS will create a positive seal even when not under full compression. The d-bulb works solely on complete compression and doesn't create much of a seal unless compressed down to line to line. The contoured sides positively force the sealing lips against the substrate like a spring. As mentioned prior, when air or water pressure is added to the uncompressed, or compressed, seal it positively actuates the seal with more energy against both substrates.

The contoured sides of the seal act as a gutter when installed vertically. Water can flow into the cup or contour and run away from the sealing lips and exit correctly.

A first embodiment of a sigma seal is illustrated as sigma seal 400. As earlier described, the seal 400 has three sealing lips 402 which will abut the top phalange 406 of an RV room or the like. The sigma seal 400 also includes, at the sides thereof, concave sections 404 which will operate to collapse when the seal is squeezed between a wall or a static surface 410 and the top phalange 406. A side of the moving RV room is also shown in FIG. 27 as side 408.

Another embodiment is a U-cup 420 shown in FIG. 28. The cup 420 includes sealing positions or edges 422 and 424. An upper section 426 is provided to abut the top flange (not shown). The pressure in the interior 428 of the U-cup 420 will cause the cup to essentially inflate.

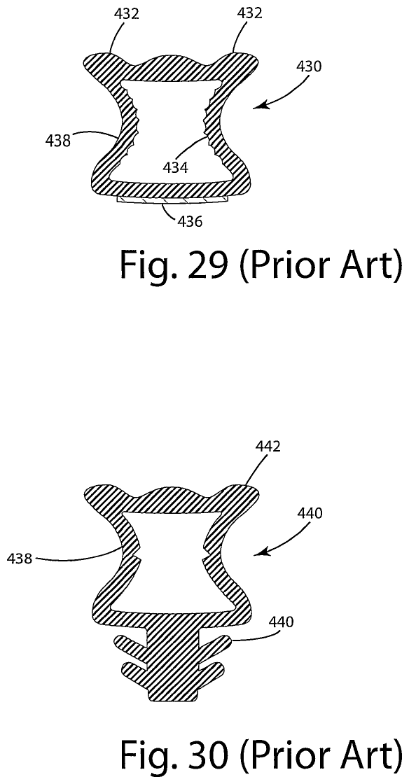

A further view of a first embodiment of the sigma seal is shown in FIG. 29 as seal 430. The seal 430 has three sealing lips 432. At an interior of the seal 430 are a set of striations 434. To seal the sigma seal 430 against a wall or static surface (not shown), a tape or high bonding medium or transfer medium 436 is shown. In addition, the seal includes concave sections 438 which will collapse as the seal 430 is compressed.

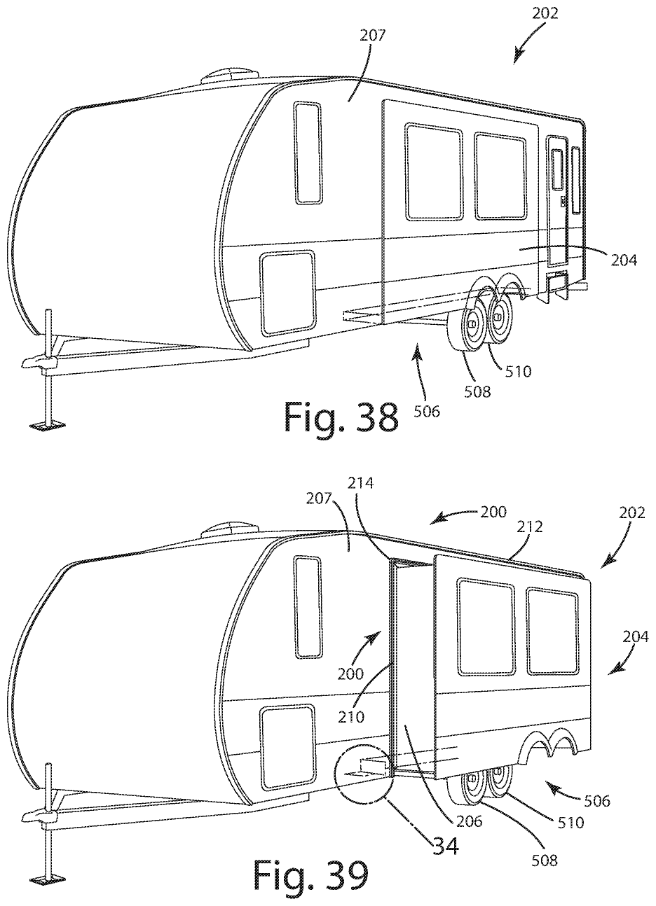

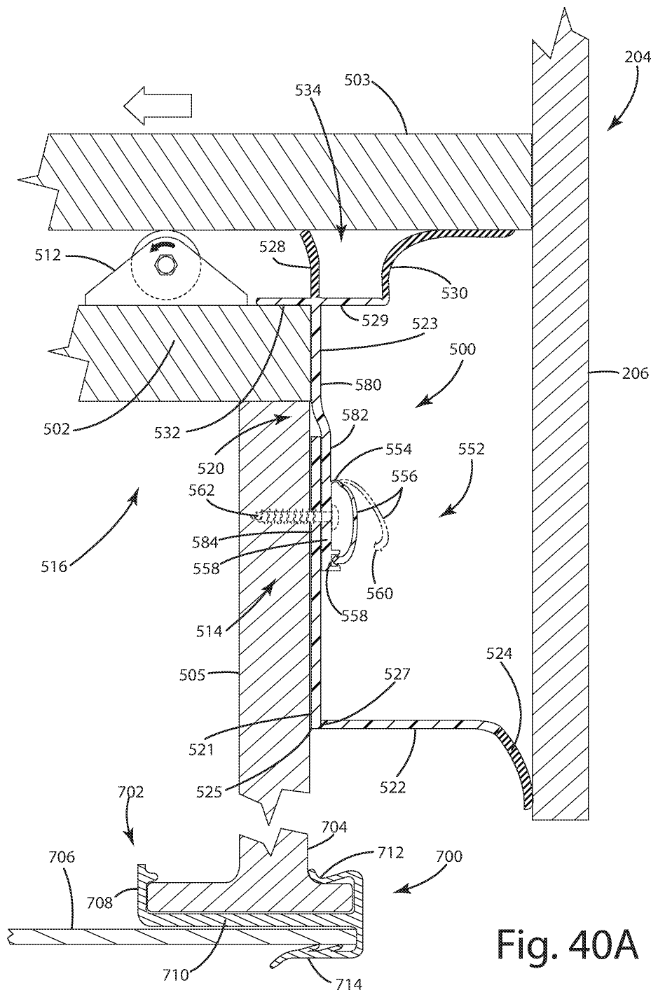

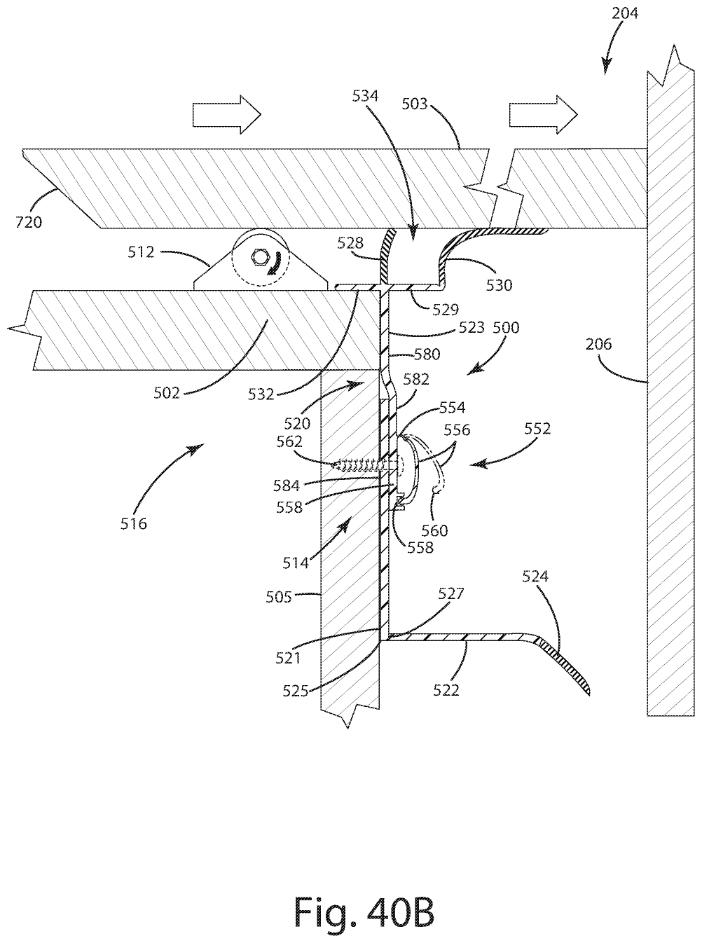

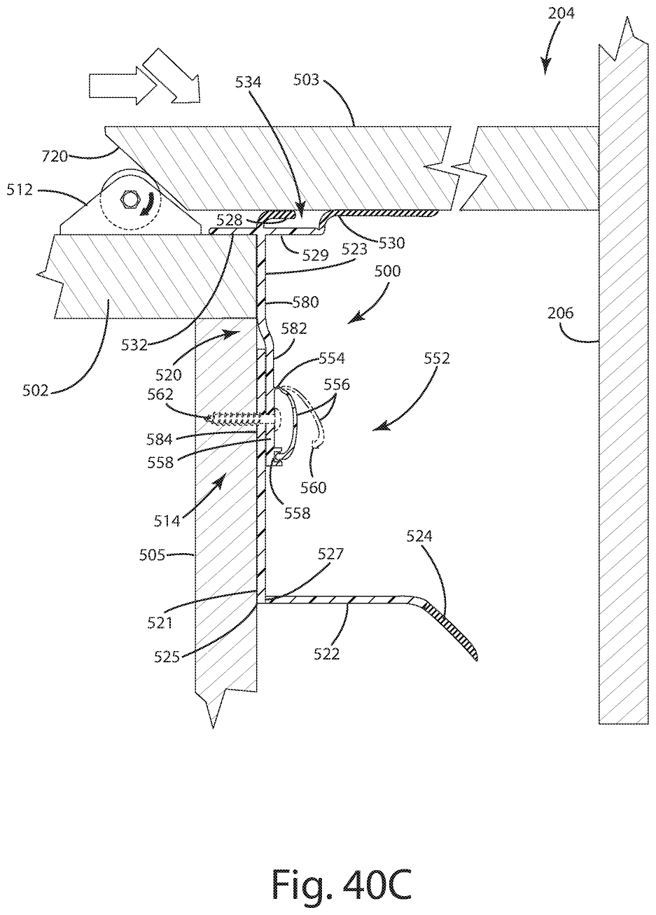

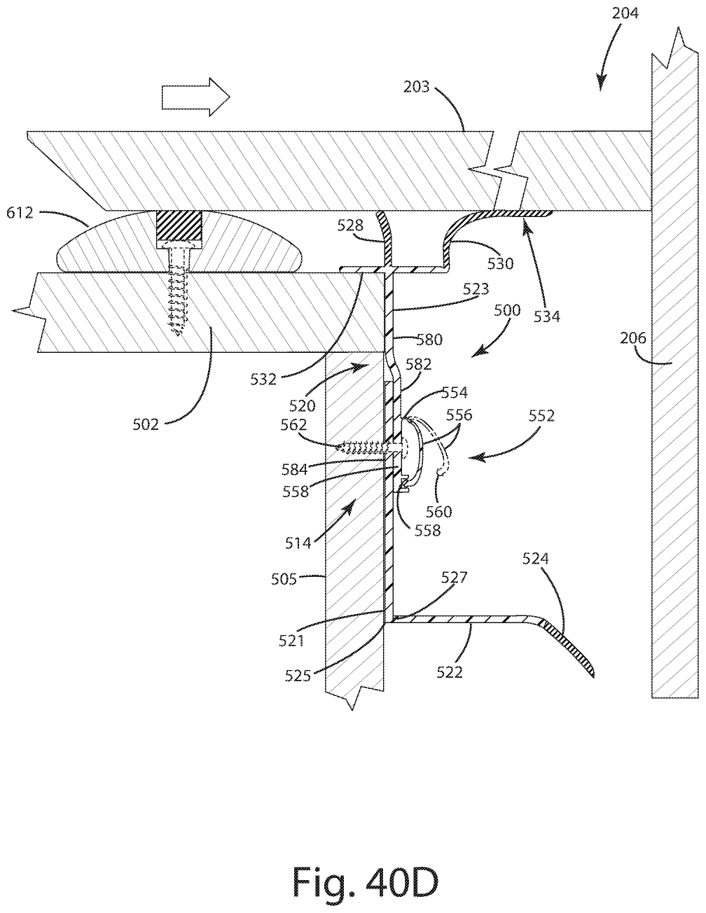

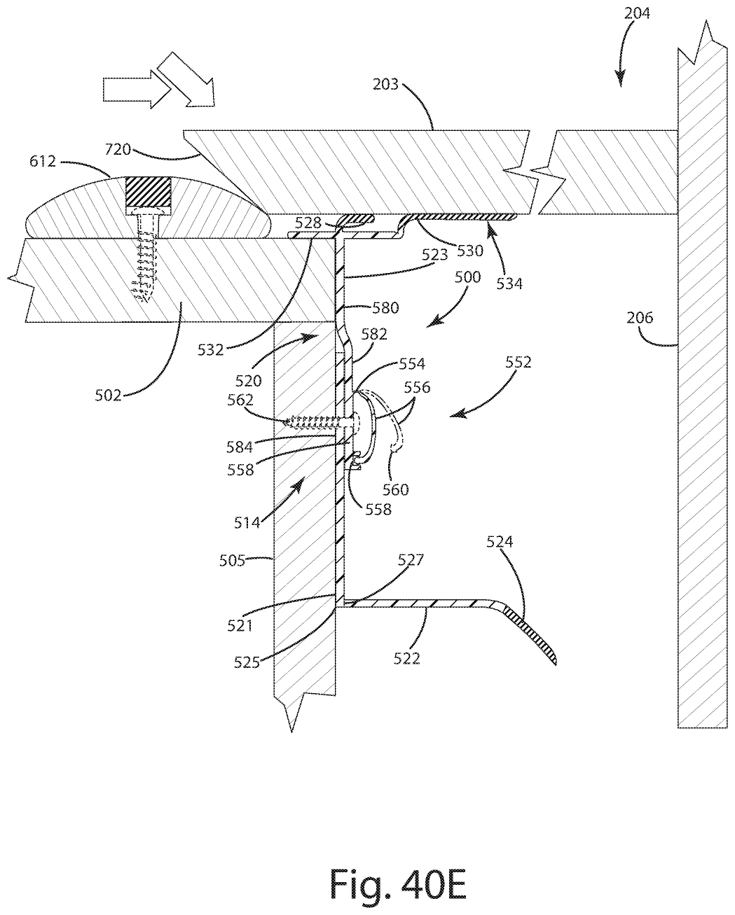

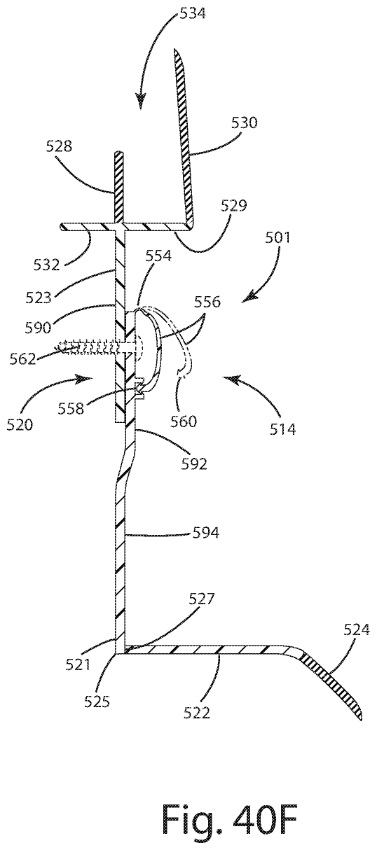

The prior paragraphs and FIGS. 1-30 describe and illustrate, respectively, known sealing systems for use with RV mobile living quarters. In accordance with the current invention, the following paragraphs and FIGS. 31, 32, 34, and 36-40F illustrate the use of bottom seal systems or assemblies. As illustrated in a partially diagrammatic view, FIG. 31 shows the location of a bottom seal system or seal assembly 500 positioned with respect to a RV floor 502. The positioning of the bottom seal system 500 relative to the RV floor 502 is further shown in FIGS. 38 and 39. Therein, conventional RV mobile living quarters 202 is illustrated, with a slide-out room 204. The RV wall 207 include a recessed floor area 504 as particularly shown in FIGS. 38 and 39. These drawings, as well as FIG. 31, also show the concept and position of a wheel well 506. The wheel well 506 is positioned around a set of wheels comprising a first wheel 508 and second wheel 510. As particularly shown in FIG. 31, and specifically with respect to functional operation of the bottom seal assemblies in accordance with the invention in FIGS. 40A-40C, the RV floor 502 can include a series of conventional rollers 512 which provide for facilitating the sliding movement of the RV room 204 as it moves between a retracted position shown in FIG. 38, and an extended position shown in FIG. 39. This functional movement of the RV floor 502 along the rollers 512 will be described in greater detail with respect to functional operation as shown in FIGS. 40A-40E.

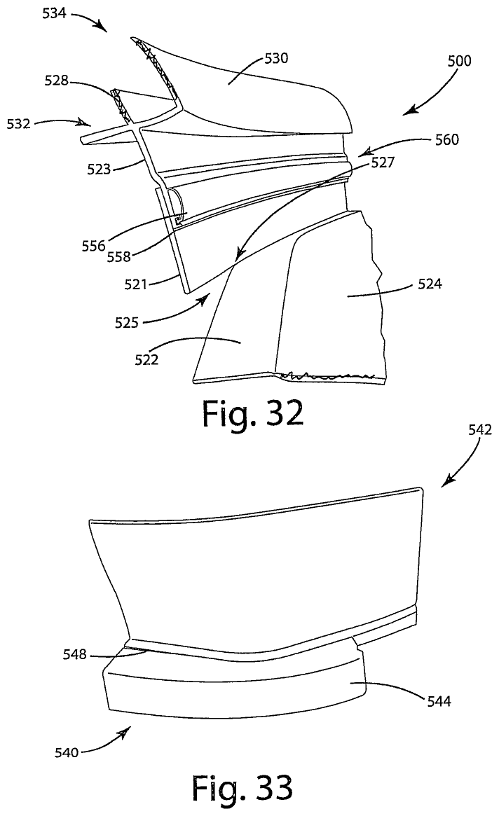

The bottom seal assembly 500 is illustrated in FIGS. 31-40B in three embodiments. Two of the embodiments involve the use of jackets which are replaceable in part and advantageous in that replacement does not require disassembly of the entirety of the bottom seal assembly or replacement of the entire assembly. This first embodiment of the bottom seal system or assembly 500 is illustrated in FIGS. 32, 34, 37A and 40A. With reference to these drawings, the bottom seal assembly 500 includes a jacket 514. The jacket 514 includes a main body extrusion 520, along with a base 522. The base 522 extends at a right angle relative to the main body 520, and form a right angled corner 527.

At an opposing end of the body 520 is an interior wipe 528. The interior wipe 528 extends from the interior leg 532. Also extending from the interior leg 532 is an exterior wipe 530. It is noted that the exterior wipe 530 is longer in length than the interior wipe 528 so as to accommodate differing close heights. A bight portion 529 extends between the interior wipe 528 and the exterior wipe 530. The wipes 528, 530 and bight portion 529 form a gutter 534 which advantageously provides for channeling and carrying off of water and debris. It should be noted that the first or interior wipe 528 is adapted to abut the room floor 503 when the room floor is in a recessed or flushed configuration. The wipe 530 is of a length or height, for accommodating room floors in raised configurations.

In accordance with specific concepts of the invention, the seal assembly 500 is adapted for use in combination with a mobile living quarters 202 as illustrated in FIGS. 38 and 39. The mobile living quarters 202 includes the slide-out room 204 (also shown in FIGS. 38 and 39) having a room interior and moveable between a retracted, closed position (FIG. 38) and an extended, open position (FIG. 39). At least one first side wall is formed in an exterior wall 207 of the mobile living quarters 202, with the first sidewall having a room opening formed therein. The first sidewall further includes an exterior surface facing outwardly from a room interior, an interior surface facing inwardly, and an end section. A living quarters floor section is formed with a first horizontal floor surface at the bottom of an interior of the mobile living quarters 202. Living quarters floor sections are positioned in part below the slide-out room 204.

A still further concept of the invention is associated with the seal assembly 500 comprising a spacing leg 532 extending outwardly from the seal body 520. The leg 532 functions to control consistent positioning to the upper surface of the RV room floor 502, and further provides for a relatively accurate and repeatable wear bar or roller installation. The use of the spacing leg 532 facilitates maintenance of the RV floor 502 on the wear bar. The use of the spacing leg 532 also facilitates maintenance of the RV floor on the roller installation. The jacket can extend from the spacing leg 532 of the seal assembly 500 along the RV floor 502 to the room end wall, and then continues so as to vertically encapsulate the room floor. In this manner, a complete seal is created.

In accordance with further concepts of the invention, the outwardly facing configuration of the jacket 514 provides an area for mechanical fastening and also for alternate seal designs. The position of the jacket 514 can also allow for the seals to be replaced, without having to remove the slide-out room. The assembly can also include a single bottom wipe 524, as previously described, which extends outwardly from the end of the second leg or base 522 of the jacket 514. Further, the assembly can include a series of bottom wipes 524 which extend outwardly from an end of the second leg of the jacket 514. The bottom wipes 524 can protrude from the second leg 522 in a fashion so as to accommodate all styles of slide-out room mechanisms and different close heights. The single bottom wipe 524 can also be structured so as to accommodate different close heights and multiple applications. The jacket 514 can be structured and designed so as to be capable of being run separated from the bottom wipe and to allow dimensional changes. The jacket can be further structured and designed so as to function as a universal jacket. In this manner, leg lengths can be varied so that they accommodate any seal sizing requirements.

The jacket 514 and the lengths of the wipes can be varied in size and dimensions, so as to accomplish different close heights and other specifications as desired by the RV manufacturer. Further, and an important aspect of the concepts of the invention, the jacket 514 can be trimmed along a 90° angle, and the spacing leg can be cut and result in a vertical piece bent over to horizontal. In this manner, a corner can be created and eliminates need for a separate corner cup. The concept of utilizing a cut away portion as shown by the cut away 525 which is particularly illustrated in FIG. 32.

In accordance with a further concept of the invention, the additional material resulting from trimming the jacket 514 along a 90° angle and extending out from under a corner can be fastened to a bottom of the RV floor 502, and utilized to completely close off the slide-out room. In this manner, further prevention is provided for intrusion by water, light, debris, and rodents and the like.

The gutter 534 is formed between the two wipes 528, 530 which channel water away from the inside of the mobile living quarters. The wipes 528, 530 are capable of being slid into place, and multiple height legs can be made to accommodate all applications, while still being used with the same jacket 514.

Still further, with respect to facilitating understanding of the invention, the bottom seal 500 can be provided about the wheel wells 506 of the RV vehicle. An area where the bottom seal 500 can be installed is typically recessed by three to four inches, and can reside over the wheels 508, 510 of the RV vehicle. This configuration is shown in FIGS. 38 and 39.

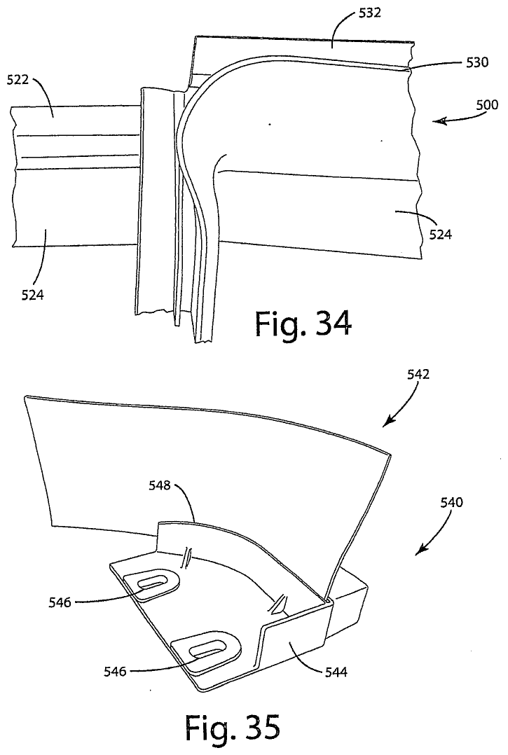

As earlier stated, one advantage associated with the current invention is the capability of replacing the use of corner cups. A typical corner cup configuration is illustrated in FIGS. 33, 35, and 36. Therein, a corner cup 540 is illustrated in a perspective view showing the front of the corner cup in FIG. 33. The corner cup 540 includes a cup base 544. As shown in FIG. 34, the cup base 544 can include a pair of apertures 546 at a rear portion of the main body of the cup 540. A notch 548 is formed within the corner cup 540 for purposes of receiving an uncut bottom seal 542. Connectors 550 (FIG. 36) can be utilized to connect corner cup 540 through the connector apertures 546 with screws or the like.

Returning to the drawings associated with the current invention, and as earlier stated, the seal 500 can be utilized in a “folding” configuration for purposes of providing an effective and complete seal. With reference to primarily to FIGS. 32 and 34, the jacket 514 can be trimmed along a 90° angle, with the cut line occurring between the body 520 and the base 522. Again, this cut in the jacket can provide the corner which eliminates the need for a corner cup.

As earlier stated, a first embodiment of the bottom seal assembly 500 in accordance with the invention is illustrated in FIGS. 32, 34, 37A and 40A. As also earlier described, the bottom seal assembly 500 shown in these drawings includes a jacket 514. The jacket 514 is constructed of a rigid material in the form of a hard rubber or the like. As also previously described, and with reference to these drawings, the bottom seal assembly 500 includes the main body 520 and base 522. Again, these components comprise the jacket 514. The bottom wipe 524 extends from an end of the base 522. The lower portion of the main body 520 and at the edge of the base 522 form a right angled corner 527. The cut away portion 525 is formed along the right angled corner 527. As earlier described, the jacket 514 can be trimmed along the 90° angle formed at the corner 527, so as to provide for the cutaway portion 525. This cut away portion 525 provides a corner for illuminating the need for a corner cup.

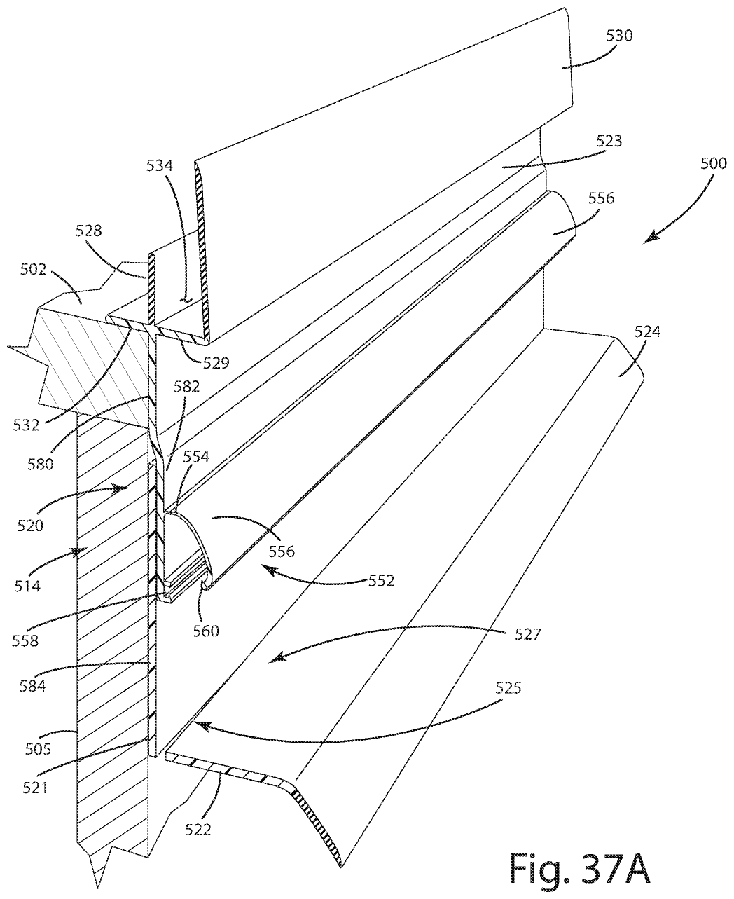

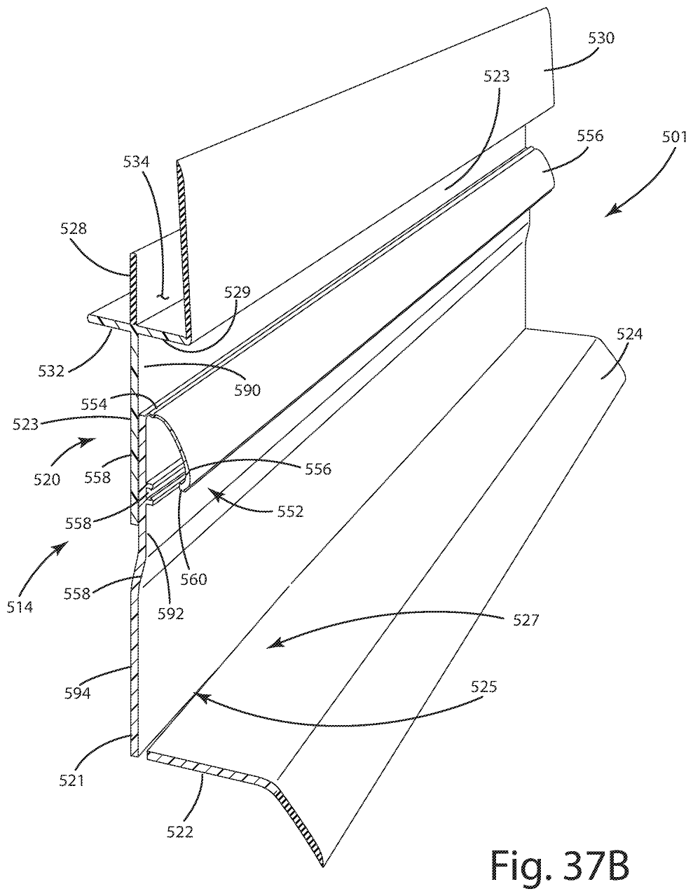

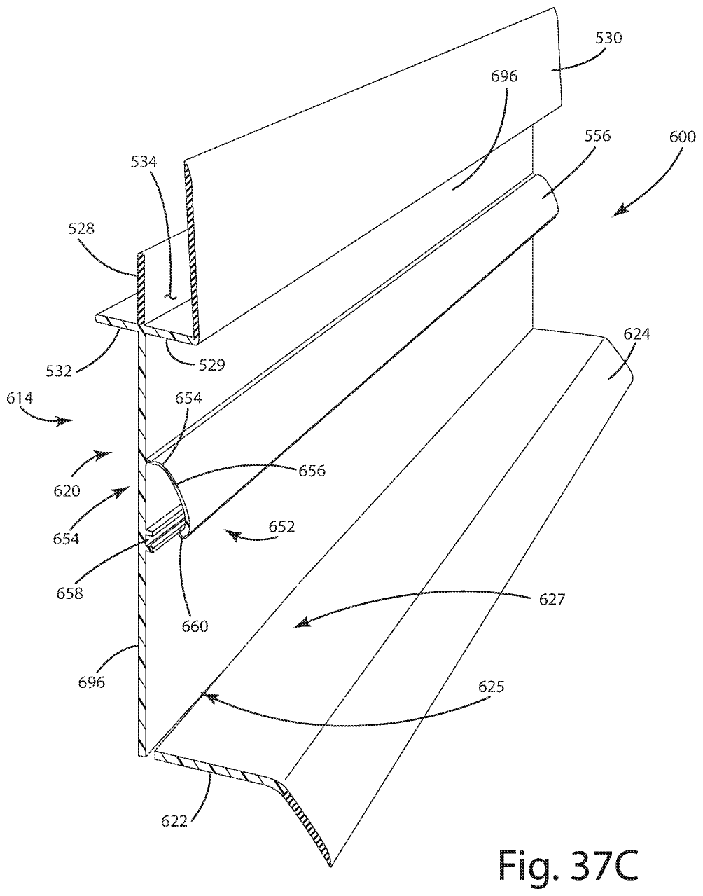

As also earlier and briefly described, the jacket 514 is configured so that prior to jacket 514, including the bottom wipe 524 is replaceable, without requirement of replacement of the entirety of the bottom seal assembly 500 or any type of disassembly of the RV slide-out room. With reference again to FIGS. 32, 34, 37A and 40A the main body 520, which comprises part of the jacket 514, consists of an upper angled section 523 formed below the interior leg 532. The upper angled portion 523 includes a straight body arm 580, and an angled body arm 582 as particularly shown in FIGS. 37A and 40A. Overlapping the angled bottom arm 582 is the upper part of a straight body arm 521, which in accordance with the description is also identified as arm 584 in FIGS. 37A and 40A. As earlier described, the straight body arm 584 can be connected through the screws 562 or other connecting means to the angled body arm 582, and to the RV floor 502.

With the foregoing configuration, a portion of the jacket 514 and the bottom wipe 524 can be removed and replaced for purposes of repair or modifications. In accordance with the invention, this capability of repair or modifications can be achieved without having to replace the entirety of the bottom seal assembly 500 and otherwise disassembly or dismantle all or portions of the RV slide out room.

In addition to the components previously described herein, the bottom seal assembly 500 can include a clip assembly 552, particularly shown in FIGS. 37A and 40A. The clip assembly 552 can be utilized to provide connecting means for connecting and securing the bottom seal assembly 500 to the RV, while covering the actual connecting elements such as screws or the like. With further reference to FIGS. 37A and 40A, the clip assembly 552 can include a folding clip arm 554 which will be utilized to specifically cover the connecting means. The clip on 554 can be connected in a similar manner to the angled arm 582, and have a flexible configuration. At the terminating end of the clip on 554 is a clip 560 which is adapted to be received within a clip slot 558 located on the angled body arm 582. As shown in FIG. 40A, screws 562 or the like can then be covered by the folding clip on 556 and received through the straight bottom arm 584 and into the RV floor. As well as providing aesthetics, the clip assembly 552 can provide a cover when the folding clip on 554 is fitted within the clip slot 558. If desired, this can be provided through an interference fit three design for purposes of hiding the screws 562 and protecting them from the elements and leaks.

In summary with effect to the embodiment of the bottom seal assembly 500 those faded in FIGS. 32, 34, 37A and 40A. The reference again to these drawings, jacket 514 includes a main body 520. The main body 520 comprises an upper portion of the jacket 514 and, particularly showing FIGS. 37A and 40A, comprises an upper straight body arm 580, and intraoral angled body arm 582 ascending downward from the body arm 580. A lower portion of the body 520 includes a straight portion 521. The upper section of the straight portion 521 can also be characterized as a straight body arm 584. The upper portion of the body arm 521 [or 584] overlaps the angled body arm 582 of the angled section 523. That is, angled section 523 comprises the straight body arm 580 and the integrally coupled angled body arm 582. A lower part of the seal 7,500 that extends outwardly from the lower end or edge of the straight body arm 521 is characterized as the base 522. The base 522 extends at a 90° angle along the line 527. As previously described, a cut away portion 525 is provided, which associates the elimination of corner cups for the seal assembly. Extending outwardly from an opposing edge of the base 522 is the bottom white 524. With this configuration, the portion of the jacket 514 consisting of the straight body arm 584, the base 522 and the bottom white 524 comprise a replacable component which can be decoupled from the upper body section 523 of the jacket 514. Accordingly, this section can be replaced and is otherwise interchangeable with differing sizes of bottom white bases, and the like. Also, a single white 524 can be utilized, and, alternatively, a multiple white configuration can be utilized. In any event, this configuration provides for replace ability of the lower part of the jacket without requiring disassembly or any other type of tear down of the RV slide out-room or other components of the mobile living quarters.

At the top portion of the jacket 514, and is also previously described herein, the seal assembly 500 includes a spacer leg 532. The leg 532 provides for the capability of controlling a consistent position of the bottom seal assembly 500 to the upper surface of the RV floor. This capability of accurate positioning provides for relatively accurate and repeatable installation of rear bars or rollers. Further, the upper portion of the bottom seal assembly 500, also previously described herein, includes an upper interior wipe 528, and exterior wipe 530. The exterior wipe 530 has a greater height or size than the interior wipe 528. A bight portion 529 extends between the bottom of the interior wipe 528 and exterior wipe 530, and thereby forms a gutter 534 between the two wipes. The gutter 534 advantageously provides for removal of debris and water from the seal assembly 500

A second embodiment of the bottom seal assembly 500 is described in subsequent paragraphs herein and illustrated in FIGS. 37B and 40B. This particular embodiment of the bottom seal assembly 500 is identified as bottom seal assembly 501 and is similar in structure to the bottom seal assembly 500 previously described herein and illustrated in FIGS. 32, 34, 37A and 40A. Referring again to FIGS. 37B and 40B, the assembly 501 includes a jacket 514. Jacket 514 is constructed of a rigid material in the form of a hard rubber or the like. The assembly 501 includes the main body 520 and a base 522. As with the previously-described embodiment, these components comprise the jacket 514. A bottom wipe 524 extends from an end of the base 522. The lower portion of the main body 520 and an edge of the base 522 form a right angle corner 527. A cut-away portion 525 is formed along the right angled corner 527. As with the previously-described embodiment, the jacket 514 shown in FIGS. 37B and 40B can be trimmed along the 90° angle formed at the corner 527, so as to provide for the cut-away portion 525. This cut-away portion 525 again provides a corner for eliminating the need for a corner cup.

In a manner also similar to the previously-described embodiment shown in FIGS. 37A and 40A, the jacket 514 shown in FIGS. 37B and 40B is configured so that the bottom wipe product 524 is replaceable, without requirement of replacement of the entirety of the bottom seal assembly 501 or any type of disassembly of the RV slide-out room. With reference again to FIGS. 37B and 40B, the main body 520, which comprises part of the jacket 514, consists of an upper straight body arm 590. The configuration is distinguishable from the body seal assembly 500 shown in FIGS. 37A and 40A. That is, in FIGS. 37A and 40A, the upper section of the main body 520 (i.e. 523) consists of a separate straight section in the body seal assembly 501, whereas the upper section 523 is an angled section in the embodiment shown in FIGS. 37A and 40A.

Descending below the straight body arm 590 and overlapping with the bottom of the same is the lower body arm 521 which comprises an upper-angled body arm 592 which overlaps with the lower portion of the straight body arm 590. Integral with the angled body arm 592 is a straight body arm 594. As shown in FIG. 40B, the straight body arm 590 can be connected through screws 562 (??) or other connective means to the angled body arm 592, and to the RV floor 502.

With the foregoing configurations, a portion of the jacket 514 and the bottom wipe 524 can be removed and replaced for purposes of repair or modifications. In accordance with the invention, the capability of repair or modifications can be achieved without having to replace the entirety of bottom seal assembly 501 and otherwise disassemble or dismantle all or portions of the RV slide-out room.

As with the embodiment of the bottom seal assembly 500 shown in FIGS. 37A and 40A, the bottom seal assembly 501 can include a clip assembly 552. The clip assembly 552 can be utilized to provide connecting means for connecting and securing the bottom seal assembly 501 to the RV, while covering the actual connecting elements such as the screws 562 or the like. The clip assembly 552 can include a clip arm 554 which covers the connecting means 562. The clip arm 554 can be connected in a similar manner to the angled arm 592, with a flexible configuration. The determining end of the clip arm 554 is a clip 560 which be received within a clip slot 558 located on the angled body arm 592. As shown in FIG. 40B, screws 562 or the like can then be covered by the folding clip arm 556 and received through the upper straight body arm 590 and into the RV floor. The folding clip arm 556 is flexible configuration and includes an end clip 560 which can be snap fitted into the clip slot 558.

In brief summary with respect to the embodiment of the bottom seal assembly 501 illustrated in FIGS. 37B and 40B, the jacket 514 includes a main body 520. The main body 520 includes an upper straight body arm 590. A lower portion of the body 520 includes an angled section 521. The upper section of the angled arm 521 can be characterized as an angled body arm 592. The lower portion of arm 521 includes a straight body arm 594. The upper portion of the body arm 521 comprising the angled body arm 592 overlaps with a lower portion of the straight body arm 590.

A lower part of the bottom seal assembly 501 extends outwardly from the lower end or edge of the straight body arm 594 and is characterized as the base 522. The base 522 extends at a 90° angle along the line 527. As previously described, a cut-away portion 525 can be provided, which facilitates the elimination of corner cups for the seal assembly 501. Extending outwardly from the closing (??) edge of the base 522 is the bottom wipe 524. With this configuration, the portion of the jacket 514 consisting of the angled body arm 592, straight body arm 594, base 522 and bottom wipe 524 comprise a replaceable component which can be decoupled from the upper body section 523 of the jacket 514. Accordingly, this section can be replaced and is otherwise interchangeable with different sizes of bases, bottom wipes, and the like. A similar wipe 524 can be utilized, or, alternatively, multiple wipes configuration can be applied. In any event, this configuration provides for replaceability of the lower part of the jacket 514 would not require disassembly or any other of tear down of the RV slide-out room or other components of the mobile (??) living quarters.

As with the embodiment of the bottom seal assembly 500 shown on FIGS. 37A and 40A, the bottom seal assembly 501 includes a spacer leg 532. The leg 532 provides for the capability of controlling aa consistent position of the bottom seal assembly 501 to the upper surface of the RV floor. This capability of accurate positioning provides for relatively accurate and repeatable installation of wear bars or rollers. The upper portion of the bottom seal assembly 501, as also previously described herein, includes an upper interior wipe 528, and exterior wipe 530. The exterior wipe 530 is of a greater height or size than the interior wipe 528. A bight portion 529 extends between the bottom of the interior wipe 528 and exterior wipe 530. The wipes and bight portion thereby form a gutter 534 between the two wipes. The gutter 534 advantageously provides for removal of debris and water from the seal assembly 501.

A third embodiment of a bottom seal assembly in accordance with certain concepts of the invention is disclosed as bottom seal assembly 600 and illustrated in FIG. 37C. The bottom seal assembly 600 is similar in structure and design to the bottom seal assemblies 500 and 501 previously described herein with respect to FIGS. 37A and 37 B, respectively. In the subsequent description of bottom seal assembly 600 and FIG. 37C, components which are substantially identical in function and design to corresponding components shown in FIGS. 37A and 37B are identically numbered. Notwithstanding a similarity in structure and design among the bottom seal assemblies 500, 501 and 600, bottom seal assembly 600 differs in that the (identified in FIG. 37C as body 620) of the jacket (identified in FIG. 37C as jacket 614) is manufactured as an integral or single piece extrusion. This format 40 extrusion is also identified as unified design extrusion 696 in FIG. 37C. With this configuration, replacement of the structure identified as the base 622 in FIG. 37C, along with the interconnected wipe 524 would require replacement of the entirety of the bottom seal assembly 600.

As further described, the bottom seal assembly 600 includes a jacket 614. The jacket 614 could be constructed of a rigid material in the form of a hard rubber or the like. The cabinet 614 includes a main body 620 and a base 622. These components comprise the jacket 614. A bottom wipe 124 extends from one end or edge of the base 622. The lower portion of the main body 620 and an opposing edge of the base 622 from a right angle corner 627. A cut-away portion 625 is formed along the right angle corner 62. As with the previously described embodiments of the bottom seal assemblies 500 and 501, the jacket 614 can be trimmed along the 90% angle formed at the corner 627, so to provide for the cut-away portion 625. This cut-away portion 625 again provides a corner for eliminating the need for a corner cup.

As earlier stated, the bottom seal assembly 600 uses a jacket 614 which is constructed in a unitary design, so that the lower part of the jacket 614 is not replaceable as a separate component from the upper portion of the jacket 614.

As with the embodiments of the bottom seal assemblies 500 and 501 shown in FIGS. 37A and 37B, expressly, the bottom seal assembly 600 includes a spacer leg 532. The way 532 provides for the capability of controlling a consistent position of the bottom seal assembly 600 to the upper surface of the RV floor. This capability of accurate positioning provides for a relatively accurate and repeatable installations of wear bars or rollers. The upper portion of the bottom seal assembly 600 also includes an upper interior wipe 528 and an exterior wipe 530. The exterior wipe 530 is of a greater height or a size than the interior wipe 528. A bight portion 529 extends between the bottom of the interior wipe 528 and exterior wipe 530. The wipes 528 and 530, along with the bight portion 529, thereby form a gutter 534 within. The gutter 534 provides for removal of debris and water from the seal assembly 600.

As with the embodiments of the bottom seal assemblies 500 and 501, the bottom seal assembly 600 also includes a clip assembly, characterized as clip assembly 652. The clip assembly 652, as with the previously described clip assemblies, is utilized to cover and protect a connecting screw which connects the jacket of the bottom seal assembly to the RV structure itself. With the bottom seal assembly 600, the clip assembly 652 will be utilized to cover and protect connecting screws (not shown) which extend through only one piece of the jacket 614 of the seal assembly 600. In contrast, the connecting screws for bottom seal assemblies 500 and 501 extend through both an upper section 523 and a lower section 521 of the jacket 514 with bottom assemblies 500 and 501. Notwithstanding this distinguishing characteristic, the clip assembly 652 is still substantially identical to the clip assembly 552.

More specifically, the clip assembly 652 comprises a means for covering and protecting the connecting means (not shown) for connecting the cabinet 614 to the RV 4. The clip assembly 652 can include a clip arm 654 which covers the connecting means. The clip arm 654 can be resilient in nature and connected at one edge to the jacket 620. The terminating end of the clip arm 654 includes a clip 660 which can be made to be received within a clip slot 658 located on the exterior of the jacket 614.

A detailed description of the functional operation of one of the bottom seal assemblies 500 will now be described with respect to FIGS. 40A, 40B and 40C. Reference is first made to FIG. 40A, which illustrates a position of the room floor 503 and the outer room wall 206 of the slide-out room 204. This particular position illustrates the slide-out room 204 with the room floor 503 and outer room wall 206 as being in a position which is substantially adjacent to the RV floor 502. That is, the slide-out room 204 is in a position where it is ______ substantially flush with the RV side wall 207 (the side wall 207 being shown particularly in FIGS. 38 and 39). The particular configuration shown in FIG. 40A, 40B and 40C illustrate the use of the bottom seal assembly 500 with sets of rollers 512 which are conventional in design. As earlier shown with respect to FIG. 31, a series of rollers 512 can be spaced apart across the upper surface of the RV deck 502. As will be described in subsequent paragraphs herein, the lower side 12 provides for a means for sliding or rolling movement of the room floor 503 on the floor 502, which remains stationary during movement of the slide-out room 204.

In addition to the foregoing, FIG. 37A and FIG. 40A illustrate the function of using a clip assembly 552 and forming the body 520 in two sections which are adjustable in position relative to each other. In this manner, the length of the body 520 can be adjusted. For purposes of providing this function, a clip assembly 552 can be utilized with a folding clip 554 formed with a first clip-arm 556 and a second clip-arm 558. Screws 560 can be positioned through apertures in the clip-arms 556, 558, and secured through the jacket 514, clips 556, 558 and into the frame of the RV room. The cover formed by the clip-arms can then be snapped shut with an interference fit tree design for purposes of hiding the screws 560 and protecting them from the elements and leaks.

Again, specifically with respect to FIG. 40A, a portion of the slide-out room 204 is shown with respect to the horizontally disposed room floor 503 and the outer room wall 206, both being shown in sectional view. Positioned adjacent the bottom of the RV 200 (FIGS. 38 and 39) is an RV floor section 516, to which the jacket 514 of the bottom seal assembly 500 is attached. The RV floor section 516 comprises a horizontally disposed RV deck 502, an RV frame 505 extending below the RV deck 502, and an underside section 507 positioned below the RV frame 505.

The bottom seal assembly 200 itself, as earlier described with respect to FIG. 37A, comprises a jacket 514 which is adapted to be secured to the RV frame 505. The jacket 514 comprises a main body 520 and base 522. The main body 520 as earlier described herein, consists of an upper straight angled section 523. The angled section 523 includes a straight body arm 580 which is substantially positioned immediately flush to and adjacent with an end of the RV deck 502. The upper angled section 523 also includes an angled body arm 582 which is integral with the straight body arm 580. Positioned below the upper angled section 523, and partially overlapped thereby, is the lower straight body arm 521. The lower straight body arm 521 includes an upper straight body arm section 584. The angled body arm 582 of the upper angled section 523 overlaps the upper straight body arm 584 of the straight body arm section 521.

As also previously described herein, the lower end of the straight body arm section 521 extends substantially at a right angle to the body arm 521 at the right angled corner 527. It is at the corner 527 where a cut out can be trimmed at a 90° angle so as to provide the cutaway portion 525 previously described with respect to FIG. 37A. The base 522 extends outwardly from the RV frame 505. The foregoing elements described with respect to the upper angled section 523, straight body arm section 521, and base 522 form the jacket 514.

Extending outwardly from a terminating end of the base 522 is the previously described bottom wipe 524. As shown in FIG. 40A, when the slide-out room 204 is substantially retracted, the bottom wipe 524 strongly abuts the outer room wall 206. This bottom wipe 524 is utilized to capture debris and water when the slide-out room 204 is near a full retracted position with the RV 202.

In addition to the components of the bottom seal assembly described in the immediately prior paragraphs, and as also previously described, the seal assembly 500 includes an interior or first wipe 528 extending upwardly from the main body 520 and the spacer leg 532. Also extending from the interior leg 532 and main body 520 is the exterior or second wipe 530. As apparent from FIG. 40, and as previously described herein, the exterior wipe 530 can be longer in length than the interior wipe 528. The purpose for this difference is to ensure that regardless of the height or vertical distance between the upper surface of the RV deck 502 and the lower surface of the room floor 503, at least one of the wipes 528, 530 will provide for a substantial abutment against the lower surface of the room floor 503. Still further, and as also previously described, the seal assembly 500 includes a bight portion 529 which extends between the lower ends of the wipes 528, 530. The wipes 528, 530 and the bight portion 529 form a gutter 534, which advantageously provides for channeling and carrying off of water and debris. It should further be noted, again, that with the exterior wipe 530 being longer in length than the interior wipe 528, that the exterior wipe 530 will still abut the room floor 503 when the room floor is in a lowered configuration. If the room floor 503 is in a configuration where the distance between the room floor 503 and the RV deck 502 is greater, the exterior wipe 530 is still of a sufficient length so as to abut the bottom of the room floor 503. In any event, the gutter 534 formed by these components provide for the carrying off of water and debris.

As also previously described with respect to FIG. 37A, FIG. 40A illustrates the use of spacer leg 532. The spacer leg 532 extends inwardly from the top of the upper angled section 523, and is positioned so as to be substantially flush with the upper surface of the RV deck 502. The length of the spacer leg 532 is selected so as to be used as a positioning device for appropriately positioning the rollers 512, also located on the upper surface of the RV deck 502.

In addition to the foregoing elements, the bottom seal assembly 500 can also be characterized as including, if desired, a lower connector assembly 700, illustrated in FIG. 40A. The lower connector assembly 700 is a component separate and distinct from the previously described components of the bottom seal assembly 500. With reference to FIG. 40A, the RV 202 includes an underside section 702. This underside section is shown in part in sectional view in FIG. 40A. The underside section 702 includes a lower RV portion 704 which forms a bottom of the RV frame 505. The lower RV portion 704 can take on somewhat of a “shoe” configuration as shown in FIG. 40A. Below the lower RV portion 704 is a bottom board 706 which forms part of the overall frame structure of the RV 202. To protect the bottom board 706 and the lower RV portion 704, the connector assembly 700 is provided. With reference to FIG. 40A, the connector assembly 700 includes an inner lip 708 which extends around and captures an inner portion of the lower RV portion 704. Correspondingly, an outer upper lip 712 is provided and wraps around and captures the external or outwardly facing portion of the lower RV portion 704. Correspondingly, extending below the outer lip 712 is an outer lower lip 714 which wraps around and captures an end of the bottom board 706. Extending between the inner lip 708 and the outer upper lip 712 is a bottom bight section 710. The bight section 710 also provides for a protection of the bottom board 706 at its upper surface and near a terminating end.

The foregoing describes the components illustrated in FIG. 40A. As earlier stated, these components were described in substantial detail in prior paragraphs herein. As described, FIG. 40A represents the bottom seal assembly 500 as the slide-out room 204 is at or adjacent to its retracted position.

FIG. 40B is substantially similar to FIG. 40A with respect to the various components of the bottom seal assembly 500. For purposes of maintaining clarity and readability of the drawings, FIG. 40B does not show a lower connector assembly 700 as illustrated in FIG. 40A. Further, FIG. 40B represents the relative positioning and movement of the slide-out room 204 as it moves outwardly from a position abutting or adjacent to the RV floor section 516. As the room 204 moves away from the RV floor section 516, the wipes 528, 530 will continue to abut the lower surface of the room floor 503. However, the bottom wipe 524 will cease to abut the outer room wall 206 as the outer room wall 206 moves away from the base 522 and associated bottom wipe 524.

In addition to the distinction regarding the position of the room 204 relative to the RV floor section 516, FIG. 40B illustrates the bevel or chamfer 720 formed at the inward end of the room floor 503. The bevel or chamfer section 720 will operate in a collaborative relationship with the roller 512 to smoothly move the room floor 503 downwardly so that the room floor 503 can smoothly move into a position where the room floor 503 is lowered so as to be in a position substantially abutting the RV deck 502. FIG. 40C illustrates the same components as are shown in FIG. 40B, but shows the room 204 moved further away from the RV floor section 516. Specifically, FIG. 40C illustrates the bevel or chamfer 720 as it has essentially moved over the rollers 512 and therefore, moves further downwardly as the room 204 is further extended. This is shown by the arrows at the top of FIG. 40C. As also apparent from FIG. 40C, as the room 204 moves further outwardly toward an extended position, the outer room wall 206 moves further away from the bottom wipe 524. The collective illustrations of FIGS. 40A, 40B and 40C show the relative positions and actions of various components of the bottom seal assembly 500 when it is in positions which could be characterized as adjacent the RV floor section 516 (FIG. 40A), and intermediate position where the room 204 has moved away from the RV floor section 516 (FIG. 40B), and when the room 204 has moved substantially away from the RV floor section 516 and the room floor 503 has moved substantially downward so as to be lowered to a position substantially abutting the upper surface of the RV deck 502.

FIGS. 40A, 40B, and 40C illustrate the use of the bottom seal assembly 500 with roller assemblies 512. As earlier stated, and for purposes of smoothly lowering the room floor 503 to the RV deck 502, wear bars can be utilized in place of the rollers 512. The use of such wear bars are shown in FIGS. 40D and 40E, with the wear bars being identified as bars 612. Such wear bars 612 are known in the art and are commercially available. It is not necessary to go through detail with respect to each component shown in FIGS. 40D and 40E. Specifically, FIG. 40D includes components which substantially correspond to those identified in FIG. 40B, and the relative positioning of the room 204 to the RV floor section 516 in FIG. 40B is also shown in FIG. 40D. The distinction between FIGS. 40B and 40D is that FIG. 40B illustrates the use of rollers 512, while FIG. 40D illustrates the use of wear bars 612. However, each functions for the same purposes.

In substantially the same manner, FIG. 40E illustrates the same relative positioning between the room 204 and RV floor section 516 as is shown in FIG. 40C. That is, in FIG. 40E, the room 204 is shown to be substantially extended relative to the floor section 516, and the room floor 503 as substantially moved over the wear bar 612 through the cooperation of the wear bar 612 with the bevel or chamfer 720.

Although internally described throughout the specification, FIG. 40F is a sectional view, in a stand alone configuration, of the bottom seal assembly 501 illustrated in FIG. 37B.

It should also be apparent to the reader that a number of different embodiments of the bottom seal assemblies described herein in accordance with the invention can be provided in modified format. For example, advantages of the bottom seal assemblies in accordance with the invention would still exist even if the room floor 503 is not moved in a vertical direction so as to be raised or lowered. Further, various connecting means can be utilized, separate and apart from the particular clip configurations described herein.

It will be apparent to those skilled in the pertinent arts that other embodiments of the invention can be designed. That is, the principles of the invention are not limited to the specific embodiments described herein. Accordingly, it will be apparent to those skilled in the art that modifications and other variations of the above-described illustrative embodiments of the invention may be effected without departing from the spirit and scope of the novel concept of the invention.

1. A seal assembly adapted for use in combination with a mobile living quarters, said mobile living quarters comprises:
a slide-out room having a room interior and movable between a retracted, closed position and an extended, open position;
a said slide-out room formed at least in part by a first vertical room side wall, a second vertical room side wall opposing said first vertical room side wall, a room end wall facing outwardly and coupled to said first room side wall and said second room side wall, and a room floor connected to said first and second room side walls and room end wall so as to form said interior room of said slide-out room;
at least one first side wall formed in an exterior wall of said mobile living quarters, said first side wall having a room opening formed therein;
said first side wall further comprises an exterior surface facing outwardly from a room interior, an interior surface facing inwardly, and an end section;
an RV floor section at the bottom of an interior of said mobile living quarters, said RV floor section being positioned at least in part below said slide-out room, and comprising a horizontal RV deck, an RV frame extending below said RV deck and an underside section positioned below said RV frame;
characterized in that said seal assembly comprises:
a jacket connectable to said RV frame and comprising a single or plural main body;
a pair of wipes extending in different heights in a parallel configuration relative to each other, and directed toward said room floor;
a bight portion extending between lower ends of each of said pair of wipes; and
said jacket is structured and designed so as to overlay and be coupled to said RV floor section in a manner so that the area formed between said pair of wipes comprises a gutter for removing water and debris.

2. A seal assembly in accordance with claim 1, characterized in that said pair of wipes comprises a first wipe adapted to abut said room floor when said room floor is in either a recessed or flush configuration.

3. A seal assembly in accordance with claim 1, characterized in that said wipes were formed so as to be of differing heights, thereby accommodating both industry floor heights of raised and flush.

4. A seal assembly in accordance with claim 3, characterized in that one of said pair of wipes is an interior wipe of a first predetermined length, and another of said pair of wipes is an exterior wipe having a second predetermined length greater than said first predetermined length.

5. A seal assembly in accordance with claim 1, characterized in that said assembly is adapted for use with means for supported a sliding movement of said room floor relative to said RV floor section when said slide-out room is moved between said retracted position and said extended position.

6. A seal assembly in accordance with claim 5, characterized in that said means for sliding said slide-out room comprises a set of rollers or at least one wear bar.

7. A seal assembly in accordance with claim 5, characterized in that said assembly further comprises a spacing leg extending outwardly from said seal body, and functioning to facilitate consistent positioning of said seal assembly relative to said RV floor, and to further provide and facilitate accurate and repeatable positioning of installation of said rollers or wear bar.

8. A seal assembly in accordance with claim 7, characterized in that said use of said spacing leg facilitates maintenance of said room floor on said wear bar.

9. A seal assembly in accordance with claim 7, characterized in that said use of said spacing leg facilitates maintenance of said room floor on said roller installation.

10. A seal assembly in accordance with claim 7, characterized in that said jacket extends from said spacing leg of said seal assembly along said RV floor to said room end wall, and then continues so as to vertically encapsulate said room floor, thereby creating a seal.

11. A seal assembly in accordance with claim 10, characterized in that said outwardly facing configuration of said jacket provides an area for mechanical fastening and alternate seal designs.

12. A seal assembly in accordance with claim 10, characterized in that the positioning of said jacket allows for said seal to be replaced, without having to remove said slide-out room.

13. A seal assembly in accordance with claim 1, characterized in that said assembly further comprises a single bottom wipe extending outwardly from an end of said jacket.

14. A seal assembly in accordance with claim 1, characterized in that said assembly, further comprises a plurality of bottom wipes extending outwardly from an end of said jacket.

15. A seal assembly in accordance with claim 13, characterized in that said bottom wipe protrudes from said jacket in a fashion so that it can accommodate all styles of slide out room mechanisms and different close heights.

16. A seal assembly in accordance with claim 10, characterized in that said single bottom wipe is structured so as to accommodate differing close heights and multiple applications.

17. A seal assembly in accordance with claim 10, characterized in that said jacket is structured and designed so that it is capable of being run separately from said bottom wipe, and to allow dimensional changes.

18. A seal assembly in accordance with claim 17, characterized in that said jacket is further structured and designed so as to function as a universal jacket in that wipe length can be varied so as to accommodate any seal sizing requirements.

19. A seal assembly in accordance with claim 17, characterized in that said jacket and wipe length can be varied in size and dimension so as to accomplish differing close heights and other specifications as desired by an RV manufacturer.

20. A seal assembly in accordance with claim 7, characterized in that said seal assembly further comprises a wear bar which runs behind said spacing leg, so as to provide for all-in-one design.

21. A seal assembly in accordance with claim 7, characterized in that said jacket can be trimmed along a 90° angle, and said spacing leg can be cut and a resultant vertical piece bent over the horizontal, so as to create a corner and eliminate any need for a corner cup.

22. A seal assembly in accordance with claim 21, characterized in that additional material resulting from trimming said jacket along said 90° angle and extending out from under a corner, can be fastened to a bottom of said RV floor, and utilized to completely close off said slide-out room, so as to increase prevention of intrusion by water, light, debris and rodents.

23. A seal assembly in accordance with claim 1, characterized in that said gutter is formed between said two wipes correctly channeling water away from the inside mobile living quarters.

24. A seal assembly in accordance with claim 1, characterized in that said wipes are capable of being slid into place, and multiple height wipes can be made to accommodate all applications, while still being used with the same jacket.

25. A seal assembly in accordance with claim 2, characterized in that said pair of wipes comprises a first wipe extending substantially perpendicular to said bight portion, and a second wipe parallel to said first wipe, and being positioned outwardly from said first wipe.

26. A seal assembly in accordance with claim 17, characterized in that said first wipe and said second wipe are of relatively different lengths so as to accommodate said room floor having a recessed configuration and a flush configuration.

27. A seal assembly in accordance with claim 17, characterized in that said first wipe and said second wipe are of relatively different lengths, so as to accommodate recessed and flush room floors having specifications in accordance with industry standards.
